(19) United States
(12) Patent Application Publication
(10) Pub. No.: US 2014/0046715 A1
(43) Pub. Date: Feb. 13, 2014

(54) SYSTEMS ANDS METHODS FOR AUTOMATED SCHEDULING

(71) Applicants: Mimi Lau, Pokfulum (HK); Tuan Anh Vu Lam, San Jose, CA (US)

(72) Inventors: Mimi Lau, Pokfulum (HK); Tuan Anh Vu Lam, San Jose, CA (US)

(21) Appl. No.: 13/571,651

(22) Filed: Aug. 10, 2012

(51) Int. Cl. G06Q 10/10

(52) U.S. Cl. CPC G06Q 10/1095
USPC 705/7.19

(57) ABSTRACT

Systems and methods are disclosed for providing multi-vendor scheduling of appointments by storing calendars for a plurality of vendors in an online data storage device; for each vendor, displaying a dashboard tab to show a summary, a calendar tab to access appointments, a customer tab to access customer details, and a settings tab to access vendor details; allowing a user to search for a specific vendor or vendor(s) that meet predetermined criteria; determining if a selected vendor has an open time slot for the user; and scheduling the appointment.

This application relates to a web based scheduling system, and more particularly to a computer-based scheduling system having multiple vendors accessible over a variety of communications networks.

### BACKGROUND

Booking service appointments and reservations over the phone and manually managing them in a paper schedule book, calendar or spreadsheet can be a tedious and time-consuming process. Online scheduling software, also commonly known as online reservation software, has quickly become a “must-have” for any service-based business or organization looking for a better and more efficient way to schedule its customer, client, patient and student appointments and reservations. Many companies have provided basic scheduling facilities in an on-line environment. However, conventional technology has so far only been successfully applied to one vendor at a time. For multiple vendors, the user must manually check the appointability of events, negotiate with all vendors on the service appointments over the phone. As a result, the user needs to maintain his/her calendar with periodic manual updates. While currently the market has many variations of online scheduling platform, they are not holistic and can be generally summarized in these two key types:

1. Industry-specific online scheduling platform that use either cloud or local servers;

2. Ancillary online scheduling capability that is attached to other core functionality software. For example, expensive software that focuses on storing patients' records and test results may also have simple scheduling capability for a doctor's patients.

Whilst the aforementioned scheduling platforms do serve the purpose of customers making online appointments either on the scheduling website or at the business vendor's website, the customers ultimately are required to go to multiple websites in order to accomplish the goal of scheduling most of their activities.

Thus, there is a disconnection between the customer and businesses. Such disconnection is inefficient from the user's perspective as the progress of the appointments needs to be constantly monitored and adjusted by human intervention. This is labor intensive and as well as being costly is difficult to perform efficiently, speedily and with high level of customer satisfaction. Furthermore, businesses can lose money when they do not fully utilize available time slots because users are not aware of the availability of open time slots. Hence, a system is needed that connects various multiple industries' businesses with customers for scheduling purposes.

### SUMMARY

In one aspect, systems and methods are disclosed for providing multi-vendor scheduling of appointments by storing calendars for a plurality of vendors in an online data storage device; for each vendor, displaying a dashboard tab to show a summary, a calendar tab to access appointments, a customer tab to access customer details, and a settings tab to access vendor details; allowing a user to search for a specific vendor or vendor(s) that meet predetermined criteria; determining if a selected vendor has an open time slot for the user; and scheduling the appointment.

Implementations of the above aspects may include one or more of the following. The process includes sending notifications to one or more friends of the user to vote on venue, date and time of a meeting. The process also includes coordinating events with the user and the friends and completing the appointment after venue, date and time are voted on and chosen. Users can click on a predetermined button (Book-It Now button) on a vendor's web site to be automatically connected to the web site. The system can send reminders to the user based on a user-selected contact channel, wherein the channels include one or more of: telephone, instant messaging, booking sites, individual company websites. The system automatically synchronizes the appointment with a user's calendar. The vendor's operating hours, maximum capacity for each hour and duration for each type of services can be updated for scheduling optimization. The maximum capacity can be itemized by employee or by table If the vendor does not respond to the appointment request within a predetermined period, the system can automatically accept the appointment. The process includes locally optimizing the calendar to fit an individual user's requirements and globally optimizing utilization of the system resources supporting the user seeking customized services.

Advantages of the preferred embodiments may include one or more of the following. The system provides a one-stop scheduling platform for end-users to make appointments and connect with service providers of multiple industries who sign up with the system. Users will get the simplicity and convenience of scheduling appointments within one platform instead of having to go into multiple websites or applications. Once appointments are made, users will also easily integrate the appointment details within the users' existing calendar tools (such as iCal). In addition to scheduling appointment for an individual user's own purpose, the platform also allows users to coordinate events with their friends and make the appointment directly on the system (after the venue, date and time are voted on and chosen on the system).

For the business vendors or service providers who sign-up with the system, they have the flexibility and choice to do the following:

1. Input all or some of the business' operating hours and schedule availability, so that users can automatically schedule appointment anytime, anywhere.

2. Opt for ability to decline or reject appointments.

3. Opt for the business not to be displayed on the list of business vendors, while that business' customers can still schedule online appointments automatically through a “book button” that is supplied by the system for display on the business' website.

The system provides a holistic scheduling platform that allows businesses from all industries to sign-up and customers can schedule appointments with these businesses through one single website or a mobile application (operated under iOS or Android). The system provides customized services which are locally optimized to suit an individual user's requirements and yet which globally optimize the utilization of the system resources supporting such customized services for each individual seeking customized services. The system allows a reduction in costs for operators by allowing customers to complete request forms and make appointments themselves without the operator requiring personnel to carry out these steps. Additionally, the system improves customer satisfaction by granting the customer better control over service appointments.

### BRIEF DESCRIPTION OF THE FIGURES

FIG. 1 shows an exemplary scheduling architecture.

FIG. 2 shows an exemplary service provider workflow.

FIG. 3A shows an exemplary service provider approval workflow.

FIG. 3B shows an exemplary booking interface for making an appointment.

FIG. 3C shows an exemplary booking user interface process for users.

FIG. 3D shows a process to cancel or reschedule an appointment.

FIG. 3E shows an exemplary process to create courses (for example, kid activities) and services (such as health and beauty services).

FIG. 3F shows an exemplary process to manage tables and shifts.

FIG. 4 shows an exemplary dashboard for the system of FIG. 1.

FIG. 5 shows an exemplary list view for health and beauty service providers.

FIG. 6 shows an exemplary calendar view for health and beauty service providers.

FIG. 7 shows an exemplary customer list view for health and beauty service providers.

FIG. 8 shows an exemplary setting screen for health and beauty service providers.

FIG. 9 shows an exemplary service pricing setting screen for health and beauty service providers.

FIG. 10 shows an exemplary staffing screen for health and beauty service providers.

FIG. 11 shows an exemplary business detail screen for health and beauty service providers.

FIG. 12 shows an exemplary operating hour setting screen for health and beauty service providers.

FIG. 13 shows an exemplary time assignment sheet for staffing health and beauty service providers.

FIG. 14 shows an exemplary list view for child care service providers.

FIG. 15 shows an exemplary customer list view for child care service providers.

FIG. 16 shows an exemplary setting screen for child care service providers.

FIG. 17 shows an exemplary course editing screen for child care service providers.

FIG. 18 shows an exemplary reservation screen for restaurant providers.

FIG. 19 shows an exemplary list screen for restaurant providers.

FIG. 20 shows an exemplary customer list for restaurant providers.

FIG. 21 shows an exemplary settings page for restaurant service providers.

FIG. 22 shows an exemplary table details list for restaurant service providers.

FIG. 23 shows an exemplary time assignment sheet for restaurant providers.

FIGS. 24-43 shows exemplary user interface screens for a mobile device.

### DESCRIPTION

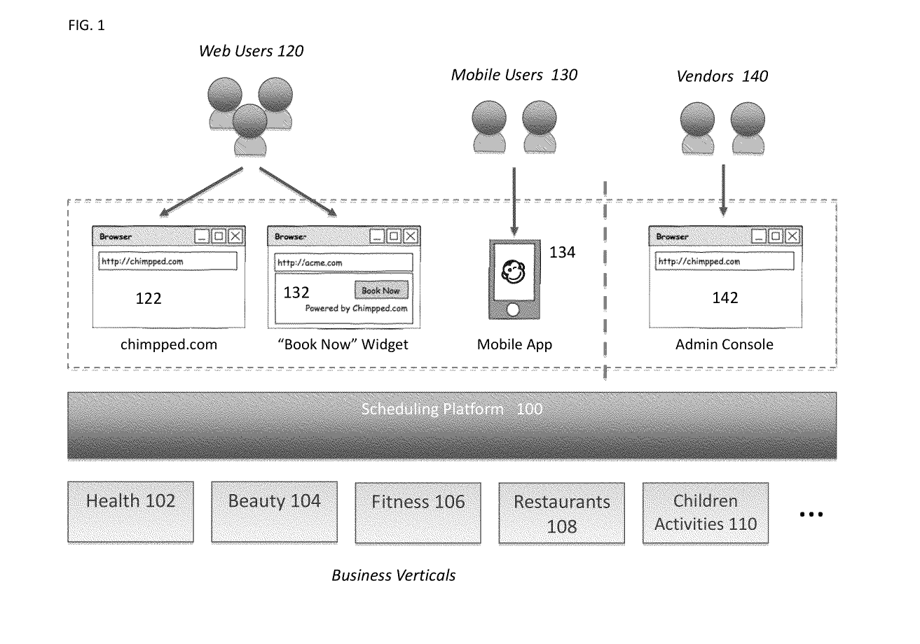

FIG. 1 shows an exemplary architecture for a scheduling platform 100. The platform 100 provides a one-stop scheduling system for end-users to make appointments and connect with service providers of multiple industries who sign up with the system. The scheduling platform 100 serves a variety of business verticals such as health vertical 102, beauty vertical 104, fitness vertical 106, food vertical 108, and children activity vertical 110, among others. For these verticals, the system provides a web-based and mobile scheduling software for connecting multiple industries' scheduling onto one platform. Industries include:

1. Health—Doctors, Dentists, Veterinarians, Hospitals, Other Specialists

2. Beauty—Spa, Nail Salon, Hair Salon

3. Fitness—Gyms, Specialized fitness centers, Sport classes, freelance fitness/sport coaches

4. Children's activity centers—Academic, Child Development, Sport, Art, Music, Dance

5. Restaurants

6. Others—Professional services, freelance/self-employed consultants, among others.

The system minimizes the hassle of booking appointments through an array of channels with no consistencies or simplicity: phone, online, booking sites, individual company websites. Back and forth email chains between friends on suggestion, deciding and booking group events and activities are minimized. The system reduces error arising when the user forgets to put the scheduled appointment onto calendar (iPhone, Outlook, Google). The system reduces the time and effort required to find a service provider with walk-in availability given an impromptu desire. Additionally, the inefficiency of manual scheduling of appointments and staff availability is avoided.

A user can sign-up with the system easily and free of charge—on www.chimpped.com or download through an app directly on iPhone or Android-operated phones. For convenience, the system allows the use of Facebook sign-in information. Once the user is signed-in, the user can search for a specific company or by certain criteria (type of service, closest date of availability, etc), and schedule the appointment. The appointment will also integrate with the user's choice of major calendar tool such as iPhone's calendar, Outlook, Google Calendar. For any alteration or cancellation of appointments booked through the system, a URL allows the user to be directed to the platform to do so. Reminders are sent to the user based on his choice of contact channel, and provide an opportunity to cancel the booking instead of “no-show” at last minute.

Business vendors who sign up for the system's scheduling services are empowered to use many functionalities that improve customer experiences, employee and customer scheduling efficiencies, and increase revenue by maximizing capacity utilization and engaging customers.

The business vendor inputs its operating hours, maximum capacity for each hour (depending on industry, maximum capacity may be further itemized by employee or by table, etc), duration for each type of services. It is anticipated that these inputs are only required to be updated once in a while. The system allows the company administrator to manually input a customer booking in the event the customer phones or walk in person. As such, once the master schedule inputs are completed, the company is able to view its appointment book on a real-time updated basis. There are fewer occurrences of writing down the wrong time, name or phone number of customers.

Business vendors also have the choice of putting a “book now” button (powered by the instant platform) on their company websites. Once a customer presses on the “book now” button, he is able to schedule an appointment with that business vendor on an interface powered by the instant. Even if the business vendor chooses not to have its business listed on the platform visible to all users, the business vendor's customers can still schedule appointment with this vendor by pressing on the “book now” button.

For businesses who want more control over appointments, they can opt to have the ability to reject or decline an appointment. After opting for such flexibility and if business vendor does not respond to the appointment request in time (specified by the business vendor), the appointment will be deemed as accepted.

The system provides customized services which are locally optimized to suit an individual user's requirements and yet which globally optimize the utilization of the system resources supporting such customized services for each individual seeking customized services. With the system, users will get the simplicity and convenience of scheduling appointments within one platform instead of having to go into multiple websites or applications. Once appointments are made, users will also easily integrate the appointment details within the users' existing calendar tools (such as iCal). In addition to scheduling appointment for an individual user's own purpose, the platform also allows users to coordinate events with their friends and make the appointment directly on the system (after the venue, date and time are voted on and chosen on the system).

The system provides a holistic scheduling platform that allows businesses from all industries to sign-up and customers 120 or 130 can schedule appointments with these businesses or vendors 140 through the system's website 122 as detailed below. Mobile users 130 can access the system though a mobile application 134 such as an Android or iPhone application. The mobile app provides a better user experience than mobile websites are capable of.

Users can also access the system through a vendor website through a “Book Now” widget 132. The “Book Now” widget is a button displayed on the vendor's web site for a user creates an appointment using the system. When the user clicks the “Book Now” button on the vendor's site, an appointment can be created with a link back to the vendor's website. One embodiment uses the Open Graph protocol to specify information about the vendor entity. When the vendor includes Open Graph tags on its Web page, the page becomes equivalent to a system's page. This means when a user clicks the “Book Now” button on the vendor's page, a connection is made between the vendor's page and the user. The vendor page will appear in the “Likes and Interests” section of the user's profile, and the vendor has the ability to publish updates to the user. The vendor page will show up in same places that the system's pages show up around the site (e.g. search), and you can target ads to people who like your content. There are two “Book Now” button implementations: XFBML and Iframe. The XFBML (also available in HTML5-compliant markup) version is more versatile, but requires use of the JavaScript SDK. The XFBML dynamically re-sizes its height according to whether there are profile pictures to display, gives the vendor the ability (through the Javascript library) to listen for like events so that you know in real time when a user clicks the “Book Now” button, and it always gives the user the ability to add an optional comment to the book now function. If users do add a comment, the story published back to the vendor is given more prominence.

Vendors 140 can access the system through an administrative console 142. In these verticals, for the business vendors who sign-up with the platform 100, they have the flexibility and choice to do the following:

1. Input all or some of the business' operating hours and schedule availability, so that users can automatically schedule appointment anytime, anywhere.

2. Opt for ability to decline or reject appointments.

3. Opt for the business not to be displayed on the list of business vendors, while that business' customers can still schedule online appointments automatically through a “book button” that is supplied by the system for display on the business' website.

The system performs aggregation of different variables and inputs for different industries in order to solve for the same thing: schedule availability. Whilst to the user, the platform gives them the same convenience of finding the schedule availability so they can book any vendors.

Next, exemplary operations within three industries: (a) health & beauty, (b) kids activities and (c) restaurants industries, are discussed. For health & beauty, the key variable inputs that solve for schedule availability or the vendor in this industry aggregates the vendor's staff's own individual schedule and service duration. The ratio of staff to customer is generally 1:1. Assume a vendor in this industry has 3 staffs who perform services. For timeslot 9-10 am, Staff A has been booked but Staff B and Staff C have not been booked. Then there exists 2 remaining available booking slots for 9 am. For restaurants, the key variable inputs that solve for schedule availability is defined by table. The vendor names each table and defines it by seating capacity and maximum time limit allowed for that table per each booking. For children activities, the key variable inputs that solve for schedule availability consists of seat capacity per course, duration of course, frequency of course (per a multitude level of units such as daily, weekly, biweekly, month and also for each of these, a subset of occurrence frequency exists such as occurring 2 days per week or 1 day per week, for example).

In one embodiment, the specific variables and inputs for exemplary industry-flows in calculating total availability (by date or by staff or by earliest availability). The system will deduct the online bookings made by users and manual bookings input by vendors to constantly arrive at “remaining schedule availability” real-time.

1. Health & Beauty Variables and Inputs
Total number of staff (service providers)
Each staff's availability on each day and time
Each staff's list of services provided (i.e. each staff is tagged with all the services she/he can provide)
Define and listing of each service
Duration of each service

2. Restaurants Variables and Inputs
Name each table and its seating capacity
Maximum time capacity allowed for each table's booking
Define each shift (breakfast, brunch, etc) duration and the tables allotted for each shift
Block any tables as desired by vendors for any one or more shifts for one or more days, recurring or not

3. Kids Activities Variables and Inputs
Name each course, seating capacity for that course and all instructors who teach that course
Input duration of each course (1 month, 2 month, Continuous, etc)
Input course occurrence frequency (daily, weekly, biweekly, monthly)
Input course occurrence day(s) (Mon, Tues, Wed, Thurs, Fri, Sat, Sun)
Input course timing for each occurrence day(s)

Web user 120 and mobile user 130 can use the system to book appointments on the scheduling platform 100. In one exemplary appointment booking workflow handles three possible usage scenario: 1) through the system's web site, 2) through a “Book Now” button 132, or 3) through a mobile application.

In one usage scenario, the user 120 visits the system's web site 220. The user may browse or search the interface for a service provider 140 to suit their needs 222. In a mobile usage scenario, the user is directed to search for service providers (222) from a mobile application (250). In one usage scenario, the user 120 clicks on a “Book Now” button at a vendor's web site (210). The user is immediately transferred to an interface on the system's web site where the user can search for a date and time for a suitable appointment. Once a desired service is found, the user is presented with times and dates of available appointments 224. Once the desired time and date are chosen, the user is asked to log in to the system using an account 226. If the user 120 does not yet have an account, he/she will create a user account 228. If the user account already exists, the user will simply log in 230. In another embodiment, the user logs in to an account previous to reserving a time and date. Once logged in, the appointment is scheduled with the user 120 and vendor 140. In some instances, approval for the appointment is not required. If this is the case, the appointment is automatically saved to the calendar of the user 236 for later viewing or reminder. A notification email is also sent to the user (238). In another instance, approval is required by the vendor. In this case, the appointment is placed on the approval queue of the vendor (240).

One example use scenario is described next. In one embodiment with a Chimpped system, a web user visits chimpped.com and search for a vendor or service provider. Once the desired provider is found, the user can then search for a time and date to reserve an appointment with the vendor using Chimpped.com. If the user does not already have a user account on chimpped.com, he will be asked to create one. The user then logs in to schedule the appointment with the vendor. If approval is required by the vendor, then the appointment is placed on an approval queue (240). If not, the date and time are saved to a user's calendar, and an email confirming the appointment is sent to the user. From the vendor's view point, the provider visits chimpped.com and creates an account and then logs in. Once signed in, the provider profile can be created or reviewed. In the event of a new business profile, the vendor will also have to upload its existing schedule data onto the platform. From this point, the vendor can also input manually booked reservations into the platform and update the schedule database.

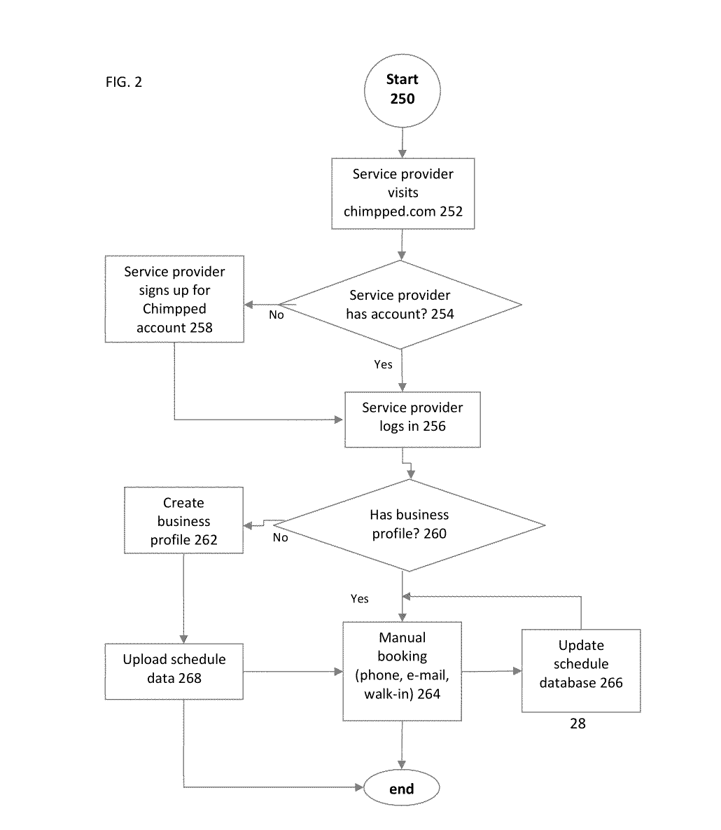

FIG. 2 shows an exemplary workflow for the service provider 250. First, the service provider visits the system web site (252). The process checks whether the service provider has a business account (254). If the vendor already owns a business account, he/she will simply sign in to the service (256). If the vendor does not have a business account, they will be asked to sign up for one on the system (258) and then logs in to the service using the account created during the registration process. The system then checks whether the service provider has a business profile tied to the account (260). If a business profile already exists, the vendor can use the system to add manually-booked appointments to the system (264). The system then updates the schedule database, adding on any new appointments (266). If the system does not find a business profile tied to the user account, the user will be asked to create the business profile (262). Details to be listed on the business profile may include: business name, street address, main telephone number, services, brief descriptions, hours of operation, price, user ratings and reviews, certifications, and logo, among other items. The vendor also needs to upload any existing manually scheduled appointments and reservations onto the system database (268).

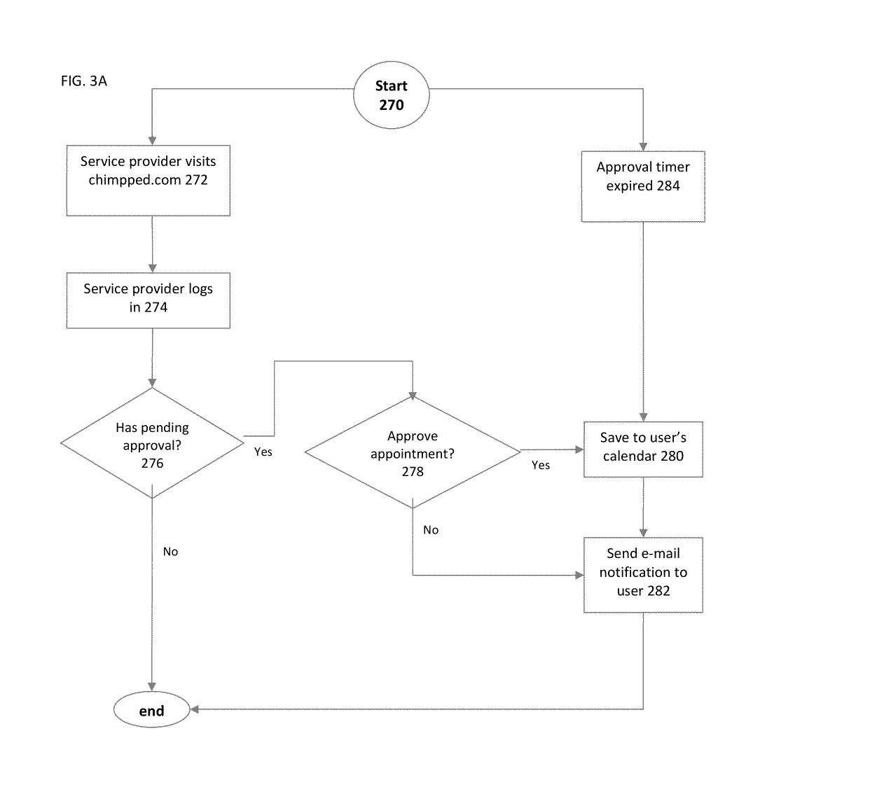

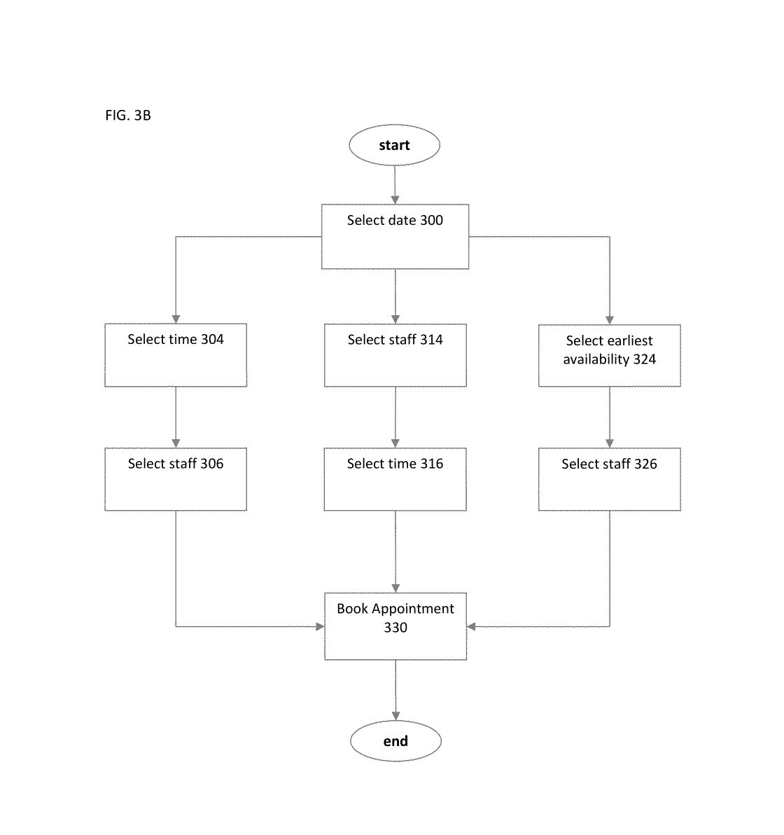

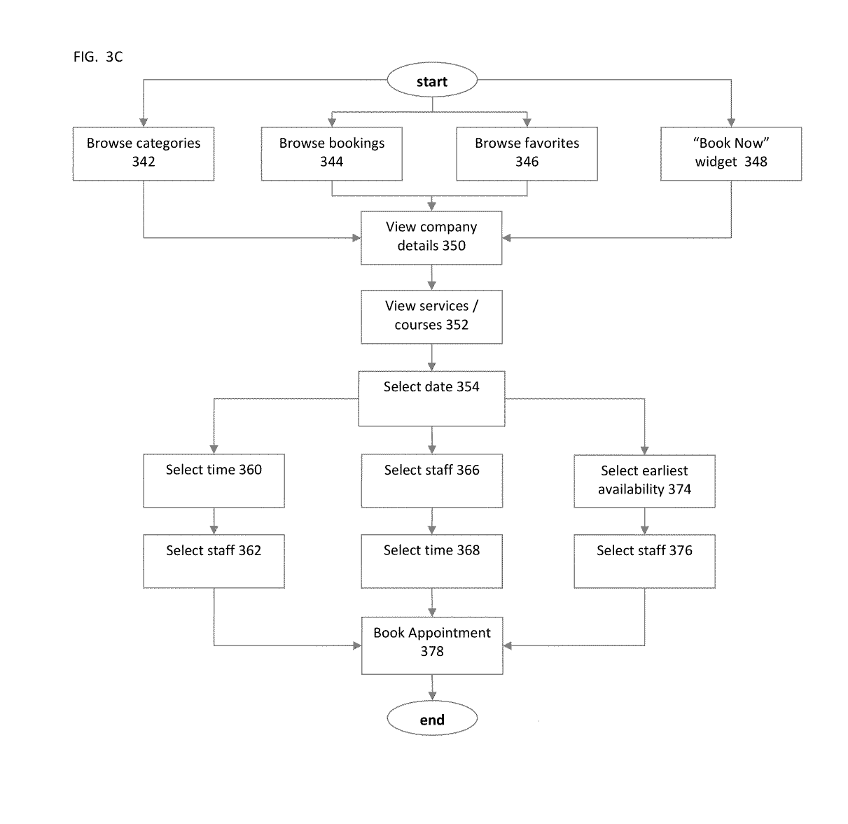

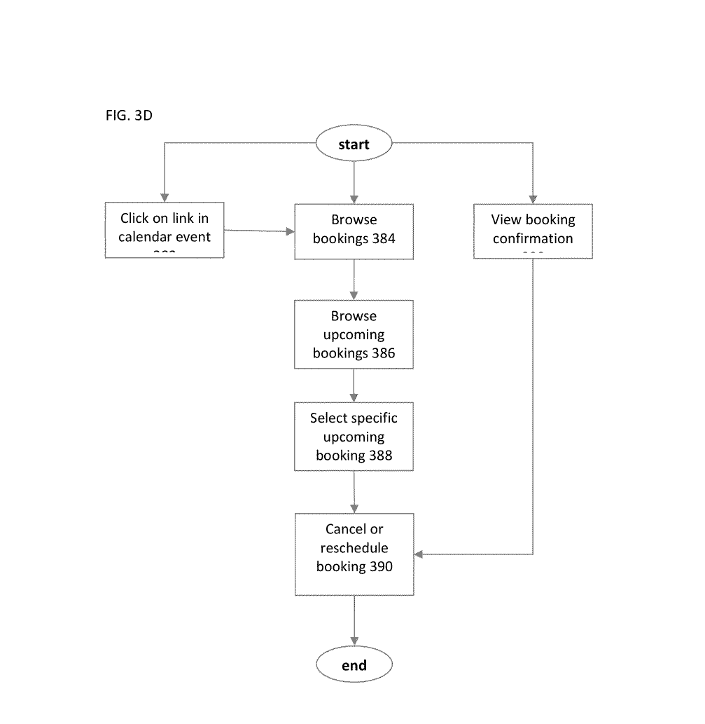

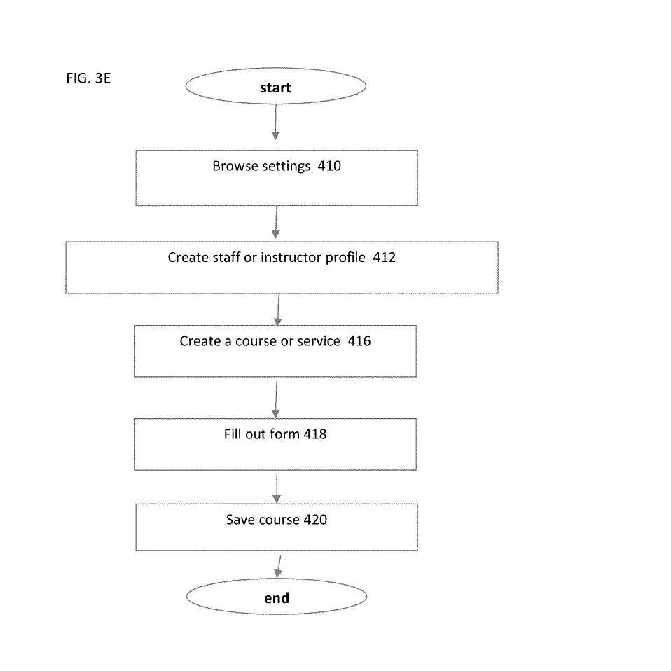

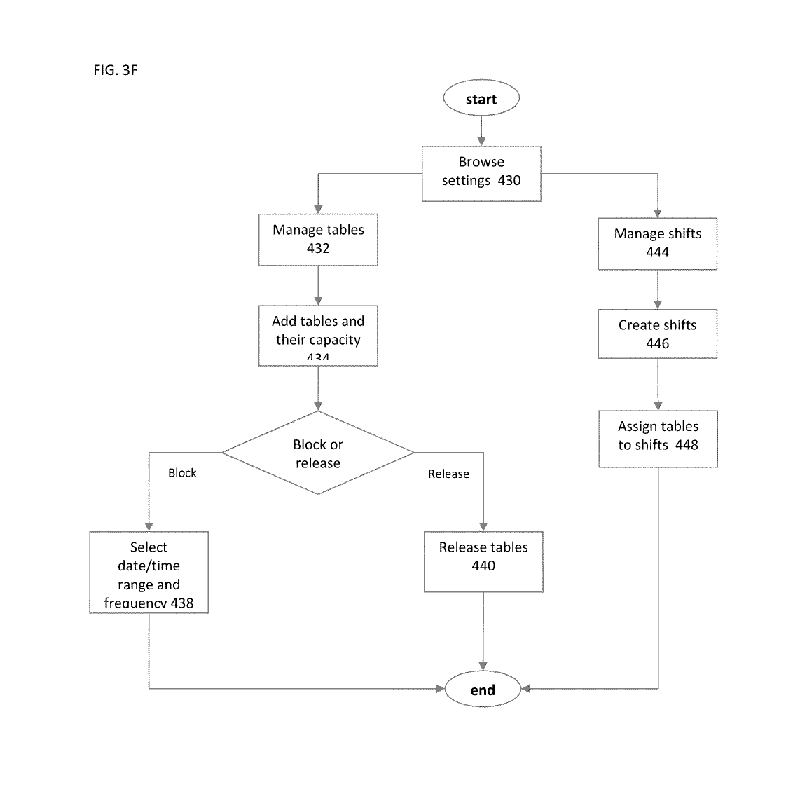

FIG. 3A shows an exemplary service provider approval workflow 270. At times, when a user books a reservation, a confirmation or approval by the service provider is required. Once the reservation is requested (270), the service provider receives a notification. By visiting the system (272) and logging in (274), a service provider can check for pending reservations that need approval (276). The vendor can decide to either approve the appointment or cancel the reservation. If approved, the appointment is saved to the user's calendar (280) and a notification email is then sent to the user's e-mail (282). If the appointment is declined, the user is similarly notified of the rejection by an e-mail message (282). For cancellation, the user can directly visit the system's web site or through a mobile application and in either case, the user logs in and cancels the appointment. The system in turn updates the schedule database and then updates the user's calendar. A confirmatory email is sent to the user and a notification is sent to the service provider.

FIG. 3B shows an exemplary booking interface for making an appointment. In this embodiment, the user selects a date (300). Then the user can select one of three options: 1) select time (304) and then based on availability select staff (306), 2) select staff (314) and based on staff availability select time (316), or 3) select the earliest available time (324) and then select available staff (326). The appointment is then booked (330).

FIG. 3C shows an exemplary booking user interface process for users. The user can perform booking by browsing categories 342, bookings 344, favorites 346, or by using a BookNow widget 348. From 342-348, the user can view company details (350) and then view services or courses 352. Next, the user selects a date (354). Then the user can select one of three options: 1) select time (360) and then based on availability select staff (362), 2) select staff (366) and based on staff availability select time (368), or 3) select the earliest available time (374) and then select available staff (376). The appointment is then booked (378).

FIG. 3D shows a process to cancel or reschedule an appointment. The user can click on a link in a calendar event (382) and browse bookings (384). The user can then browse upcoming bookings (386) and select specific upcoming bookings (388). From 388 or from a booking confirmation (392), the user can cancel or reschedule the appointment (390).

FIG. 3E shows an exemplary process to create courses (for example, kid activities) and services (such as health and beauty services). The vendor browse the settings tab (410) and creates staff or instructor profile(s) (412). The vendor then creates a course or a new service (416), fills out the form for more information on the new course or service (418), and saves the new course or service (420).

FIG. 3F shows an exemplary process to manage tables and shifts. This process is optimized for services such as restaurants. In this process, the vendor browses the settings (430). From the settings tab, the vendor can manage tables (432). For example, the vendor can add tables and indicate table capacity (434). The vendor can also decide whether to block or release tables (436). If blocking tables, the vendor can select the date, time, range and frequency where tables are to be blocked (438). If releasing tables, the vendor can select tables to be released (440).

From the settings tab, the vendor can also manage shifts (444). Shifts can be created (446) and tables can be assigned to shifts (448).

Next, exemplary user interface designs are detailed.

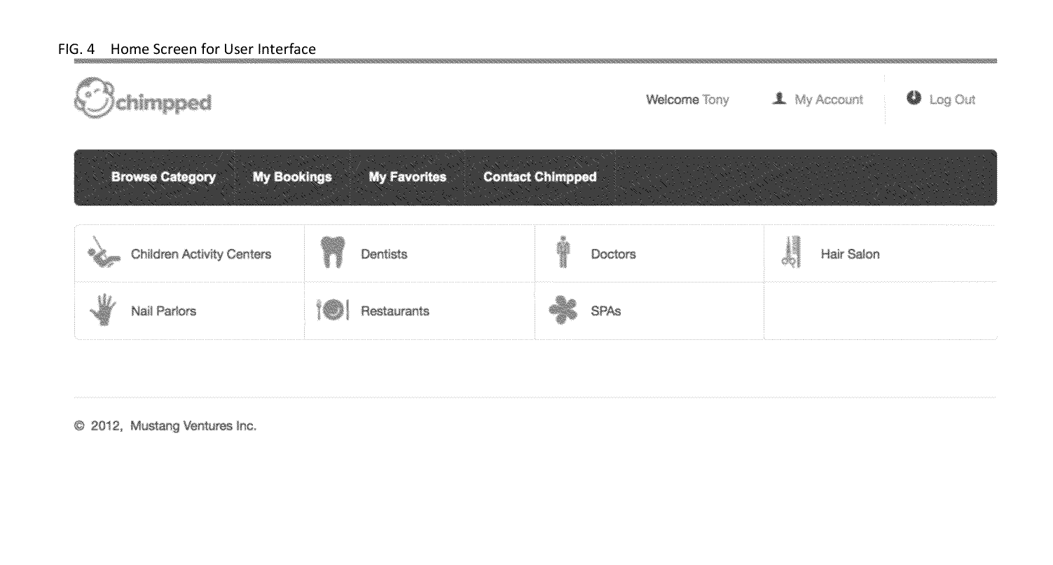

FIG. 4 shows an exemplary display to a service provider, showing statistics such as number of appointments, new clients, and percentage of schedule utilization. In addition, latest activities on the account are shown.

FIG. 5 shows an exemplary list view for health and beauty service providers. In this embodiment, the list view provides service information such as appointment date, start and end time, staff on duty, and time of booking.

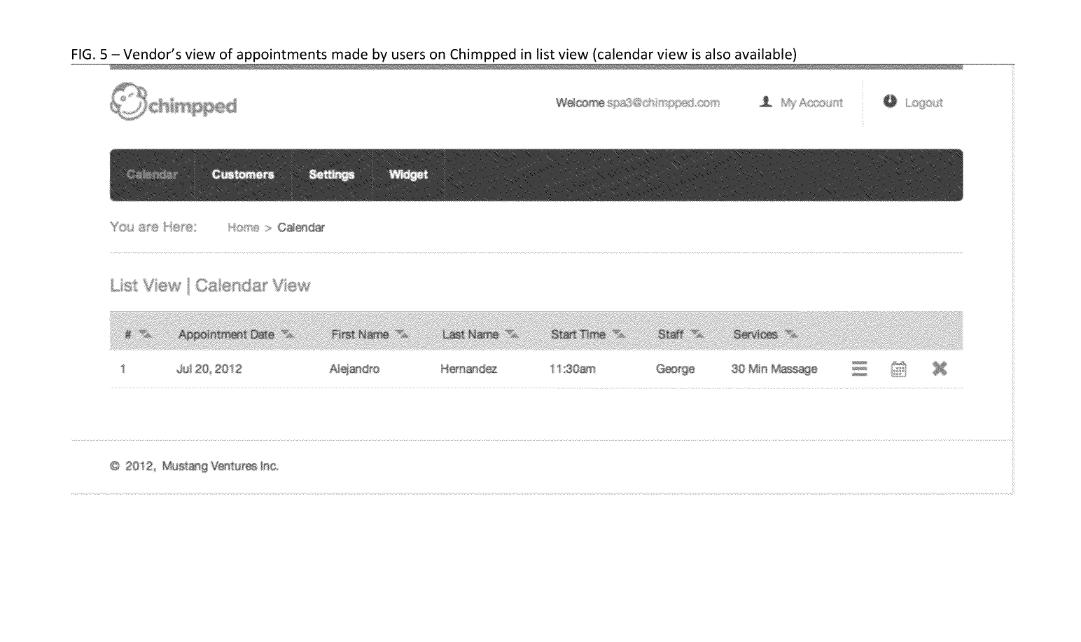

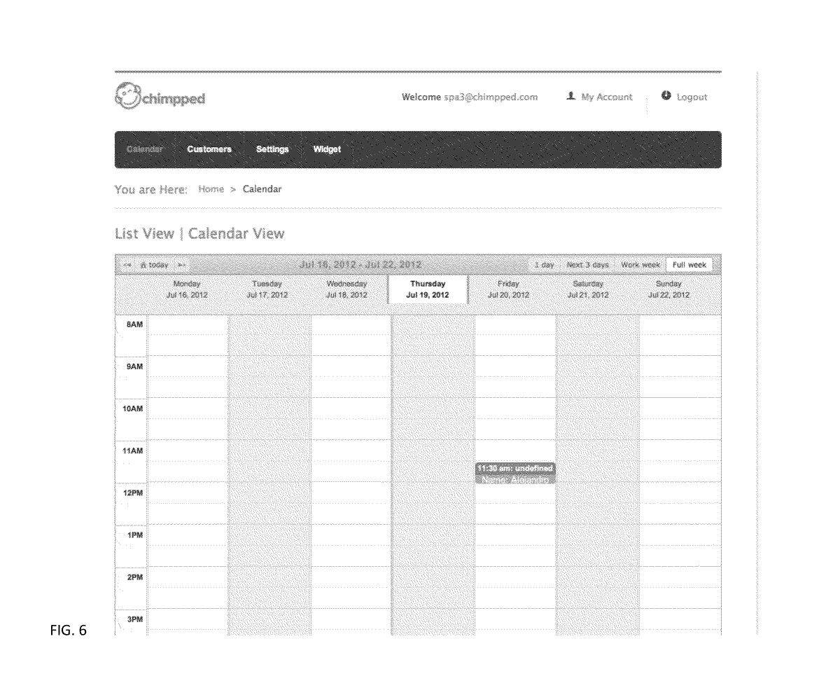

FIG. 6 shows an exemplary weekly calendar view for health and beauty service providers. In this embodiment, time slots for appointments are shown. Scheduled appointments are highlighted. Included in the highlighted appointment, further details regarding the appointment can be viewed and edited.

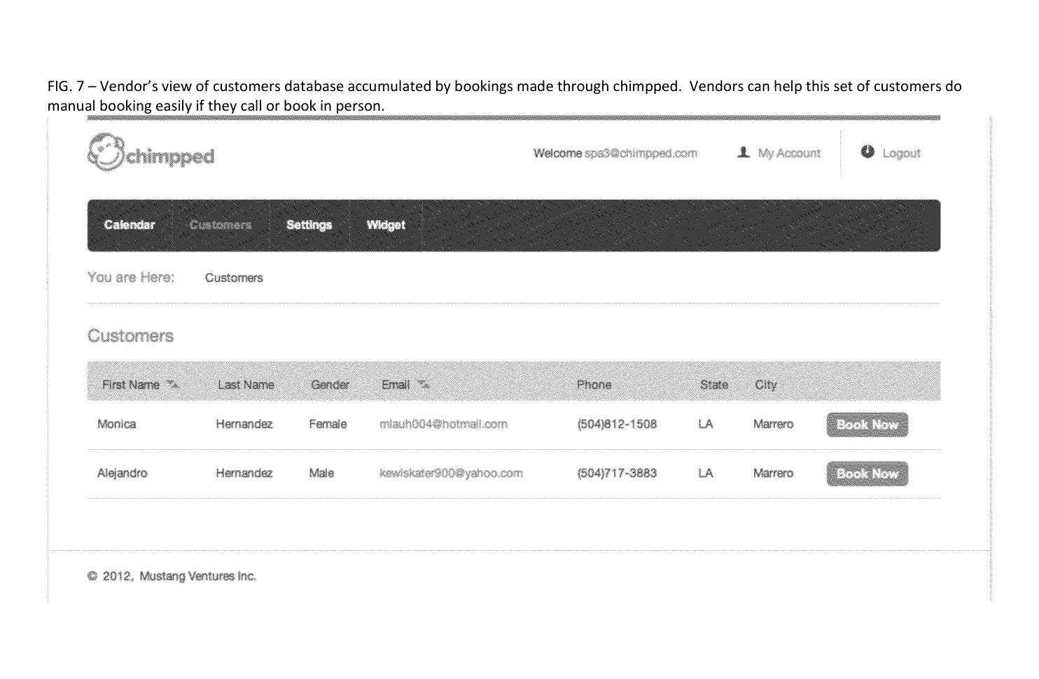

FIG. 7 shows an exemplary customer list view for health and beauty service providers. This list shows customer details such as name, phone number, email, and city of residence. This embodiment also shows a book now button allowing the service provider to manually input any requested appointments.

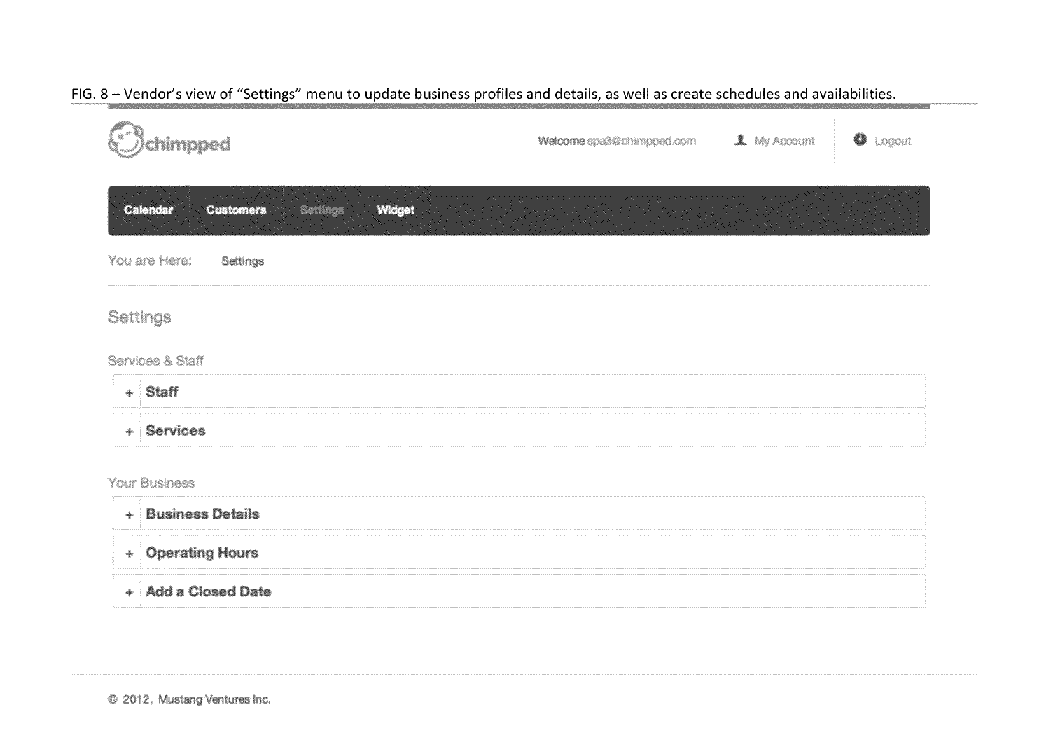

FIG. 8 shows an exemplary setting screen for health and beauty service providers. This embodiment allows for the editing of listed services and names of staff members. Service providers can also change business details, such as operating hours, closed dates, and payment information.

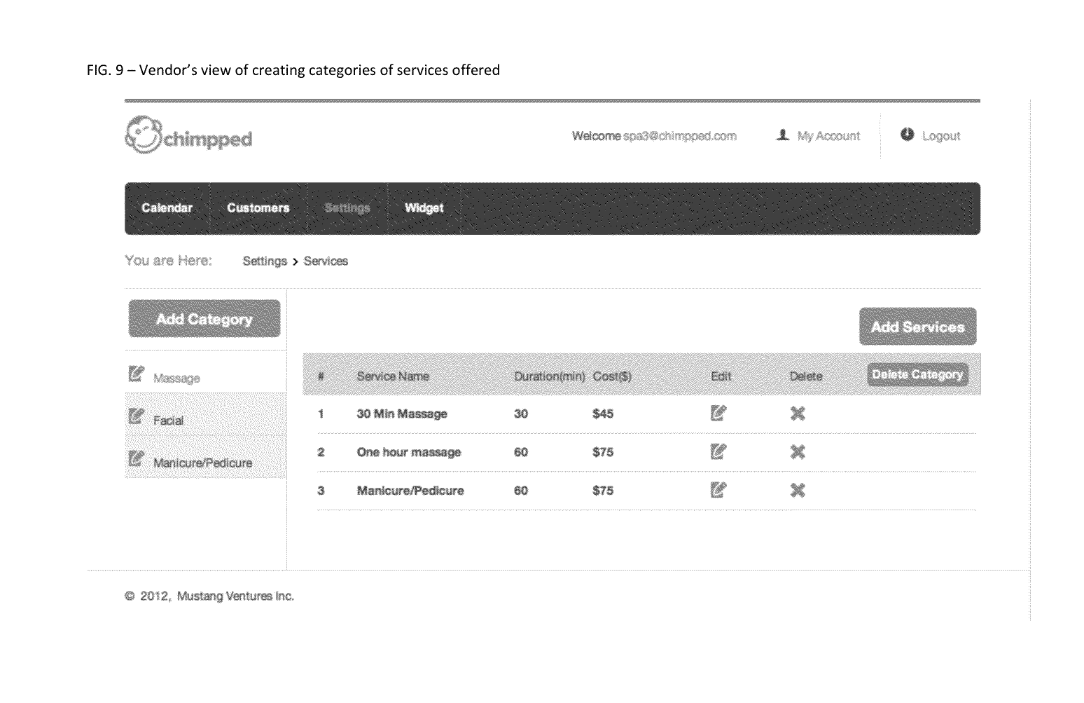

FIG. 9 shows an exemplary service pricing setting screen for health and beauty service providers. In this embodiment, the service provider can add, edit, and delete services, which are grouped under categories. Also listed are the service name, time duration, and cost.

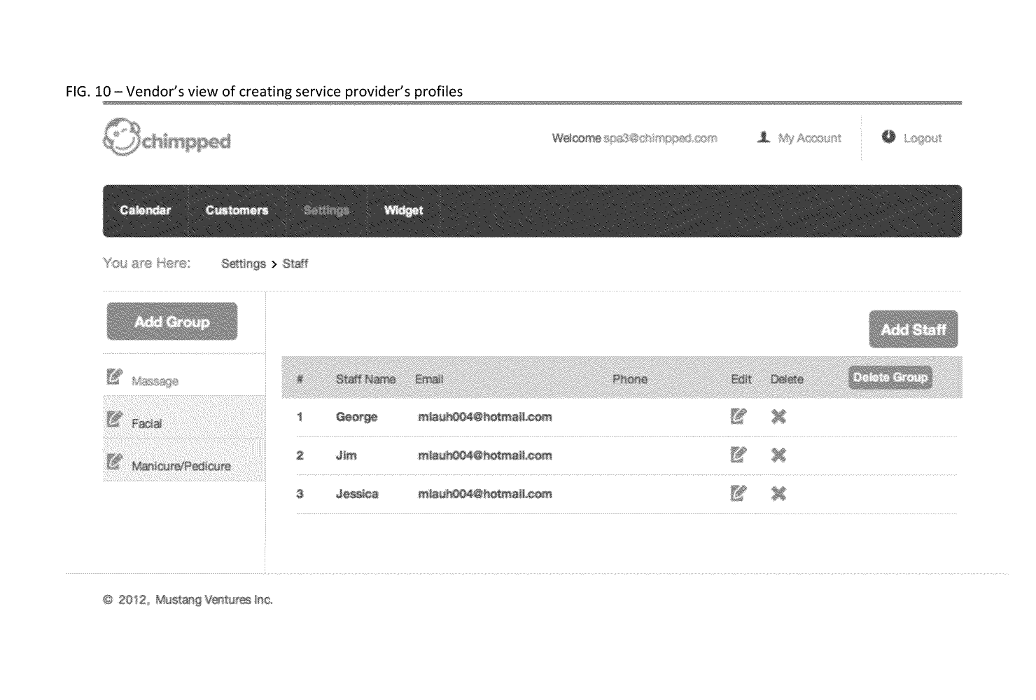

FIG. 10 shows an exemplary staffing screen for health and beauty service providers. This embodiment lists staff name, email, and phone number by the category of their work. Service owners can also change staff details, and add new staff and or groups of employees.

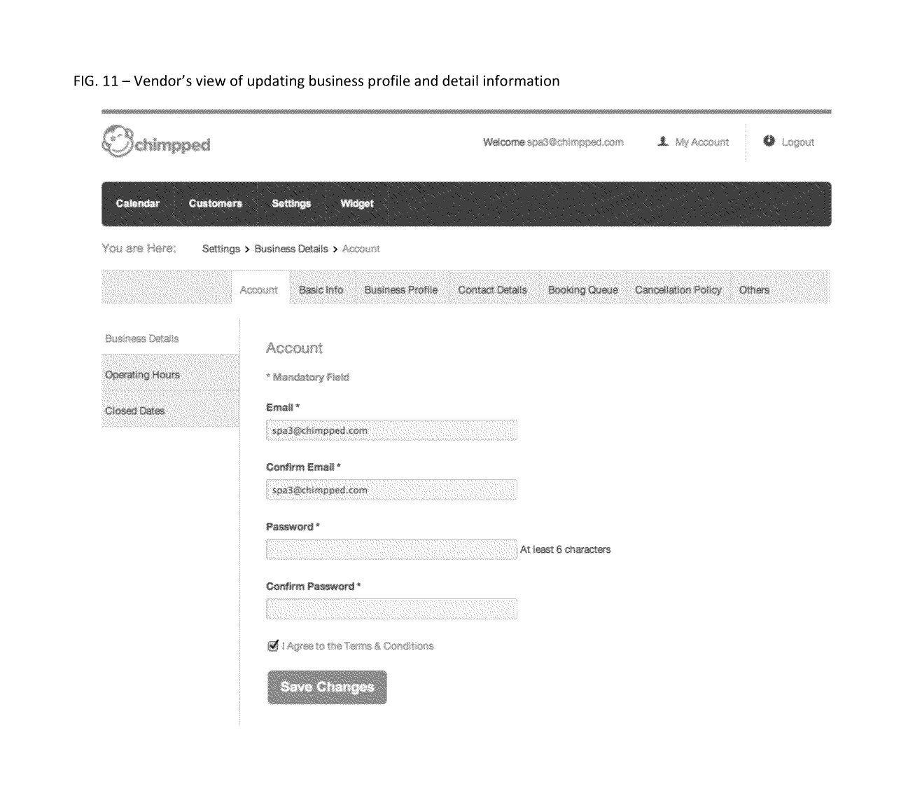

FIG. 11 shows an exemplary business detail screen for health and beauty service providers. In this embodiment, business providers can view details of their account and other editable business details, such as company name and description.

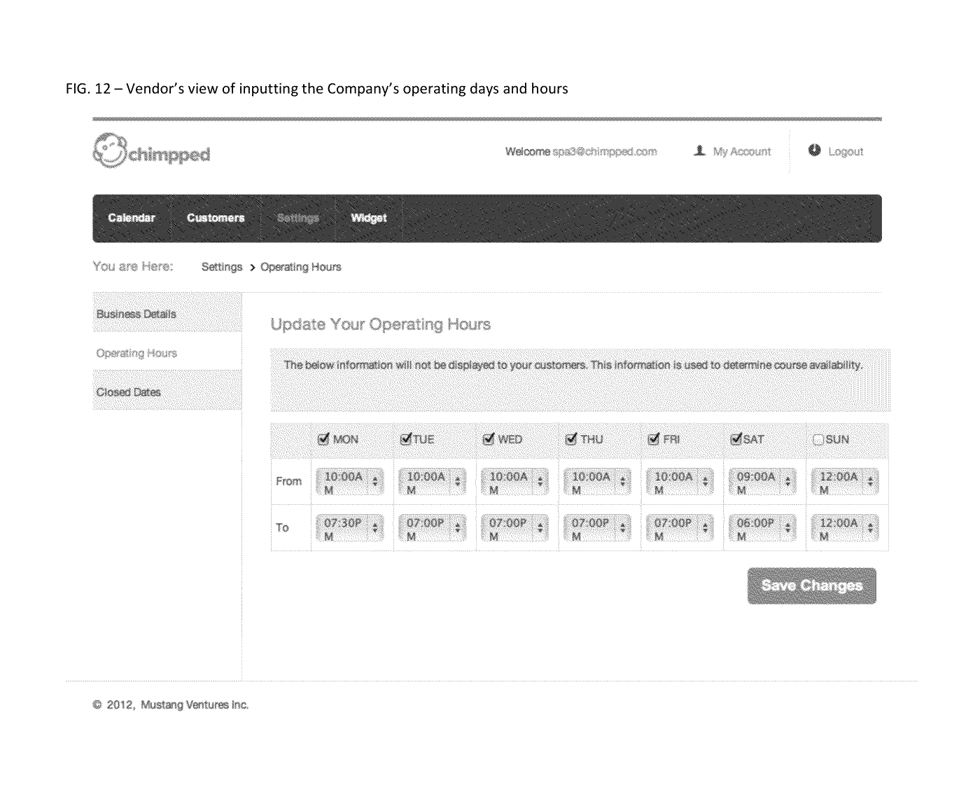

FIG. 12 shows an exemplary operating hour setting screen for health and beauty service providers. In this embodiment, service hours are editable by day and time. Names of the days have check marks next to them which can be checked or unchecked depending on availability. Operational hours can also be changed according to options from a drop down menu.

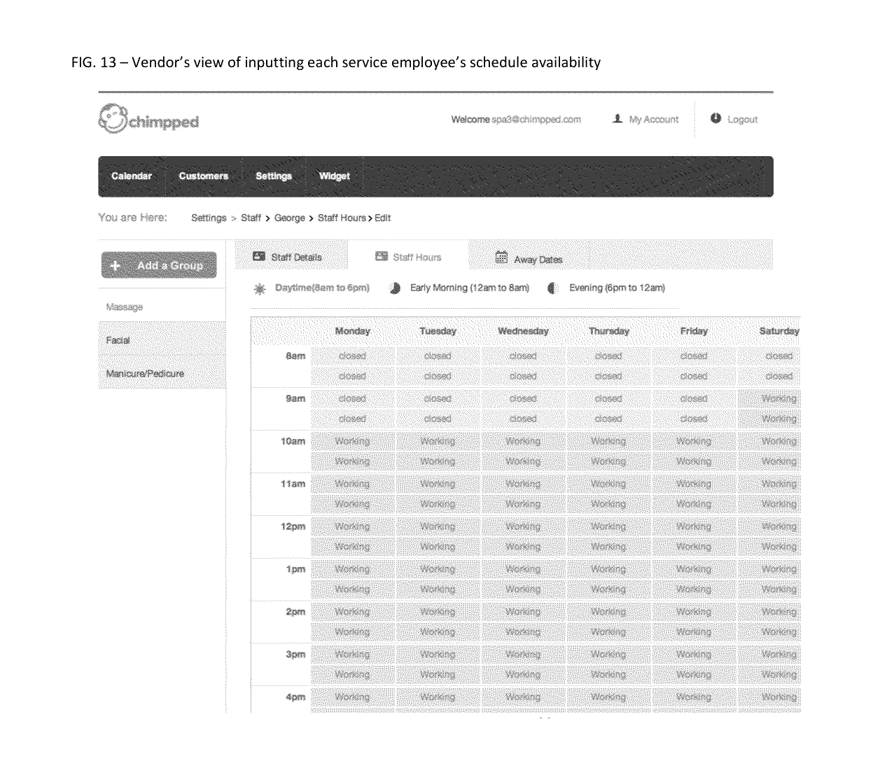

FIG. 13 shows an exemplary time assignment sheet for staffing health and beauty service providers. In this embodiment, a weekly calendar similar to that described in FIG. 6 is shown. Instead of highlighted appointments, however, the work schedule of a staff member is shown. A staff member's time slots can be either colored green for online and working, blue for offline and working, or yellow for not working depending upon their work status.

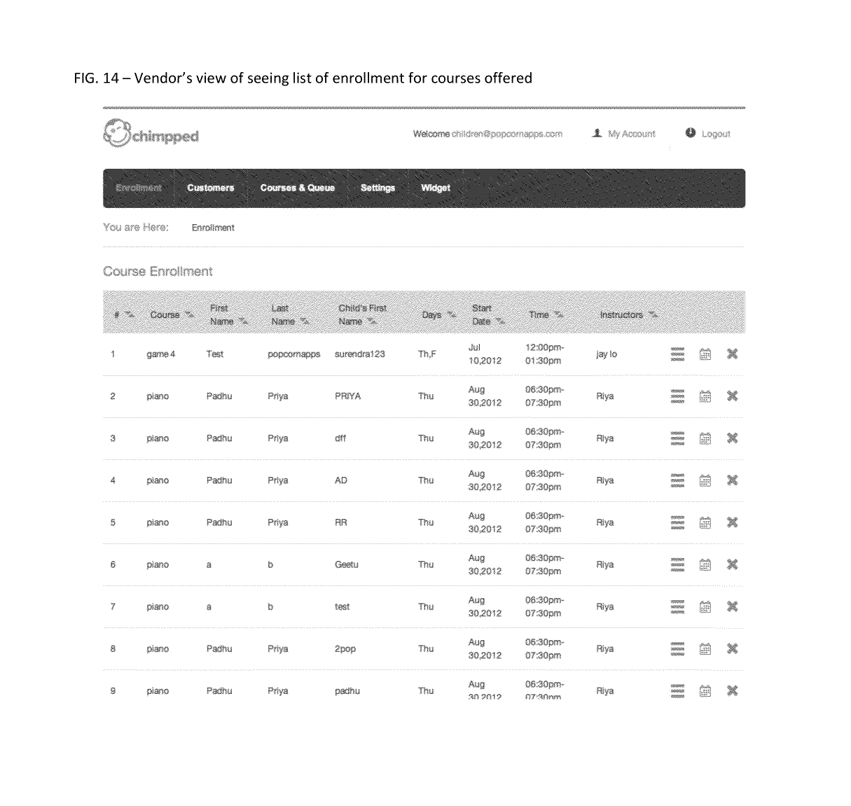

FIG. 14 shows an exemplary list view for child care service providers. In this embodiment, courses held at a child care center are listed, along with details of course dates, days of the course, time of the course, and instructor names. The class may also be rescheduled by the service provider.

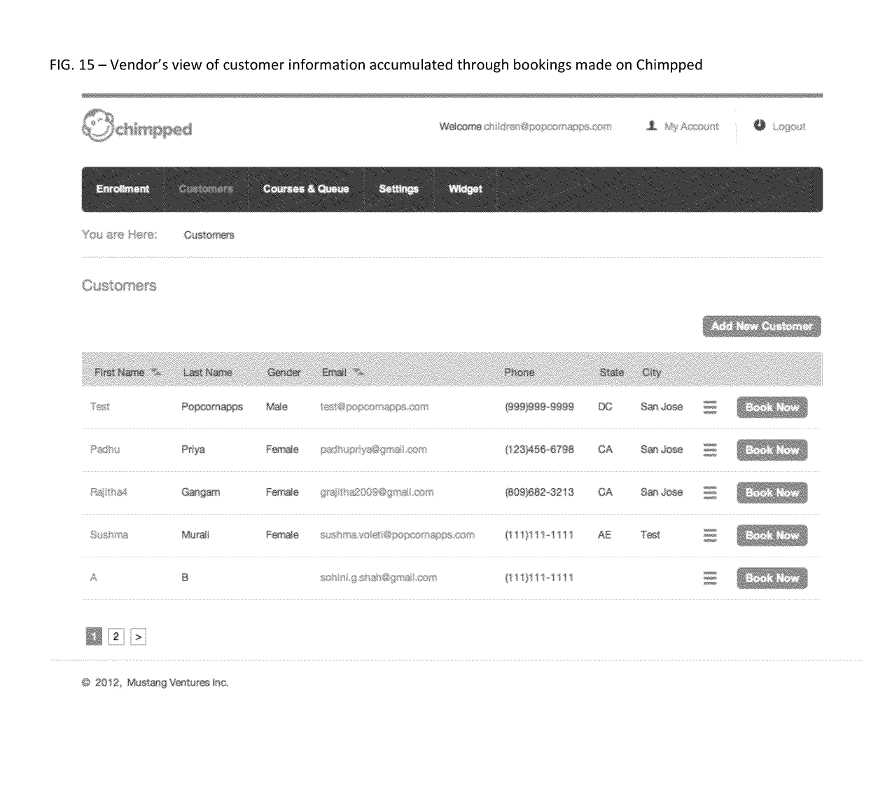

FIG. 15 shows an exemplary customer list view for child care service providers. This embodiment shows customer names, customer contact information, and city of residence. A new user booking button is included on this page to accommodate for new unlisted customers. A book now button is also included next to the customer information so that a service provider may book an appointment manually in that customer's name.

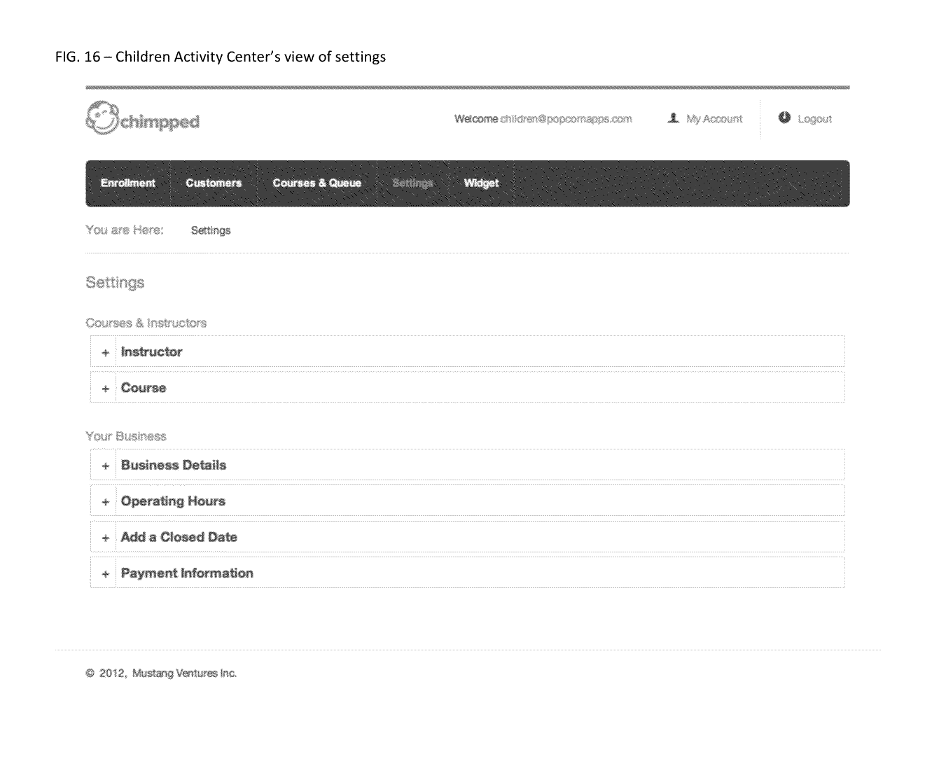

FIG. 16 shows an exemplary setting screen for child care service providers. On this embodiment of a settings screen, there are several editable items listed: course details, instructor names, business details, operating hours, close dates, and payment information.

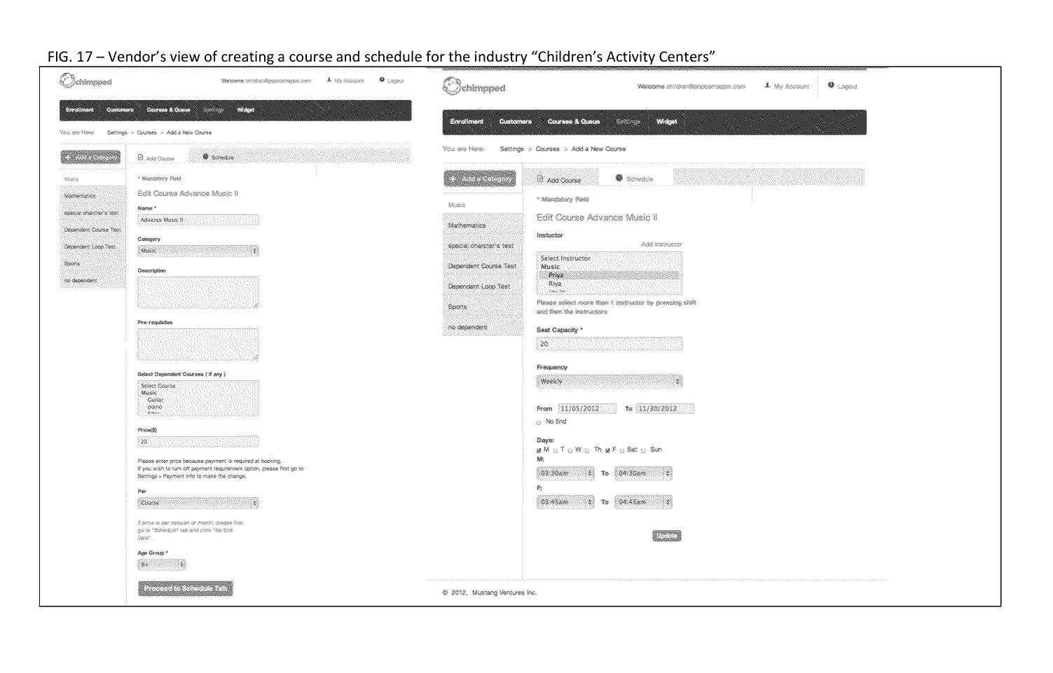

FIG. 17 shows an exemplary course editing screen for child care service providers. On this screen details for a class are shown, including name, category, description, and prerequisites. On the right hand side of the screen, instructor information, class frequency, class date and days, and class times are able to be changed.

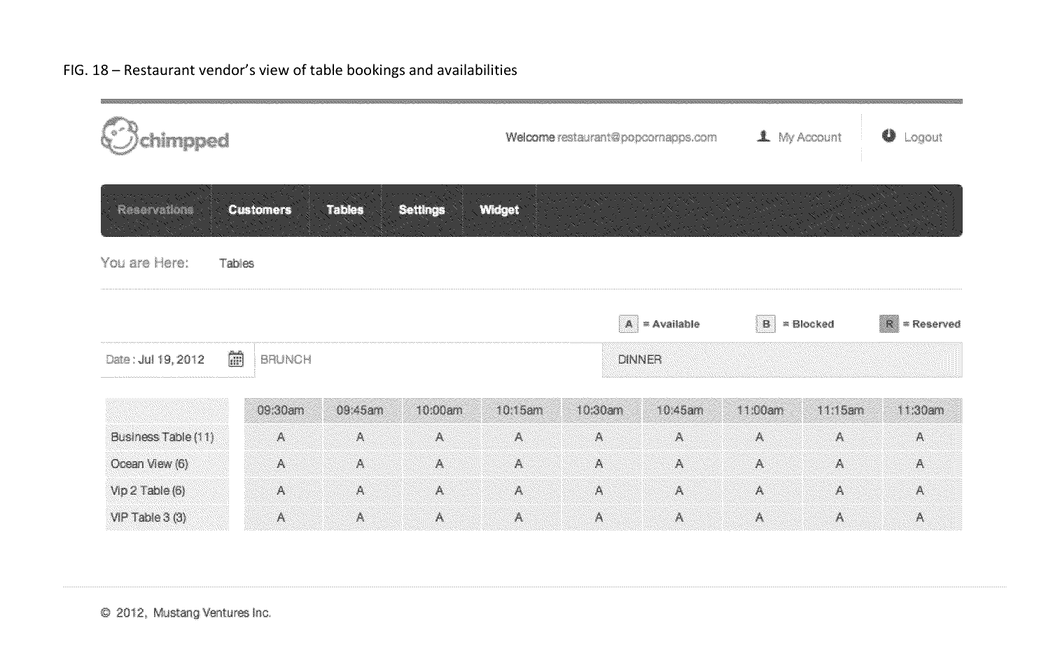

FIG. 18 shows an exemplary reservation screen for restaurant providers. This embodiment shows the customer name, time and date for the reservation, party size, and confirmation number. This page also allows for the rescheduling of the reservation.

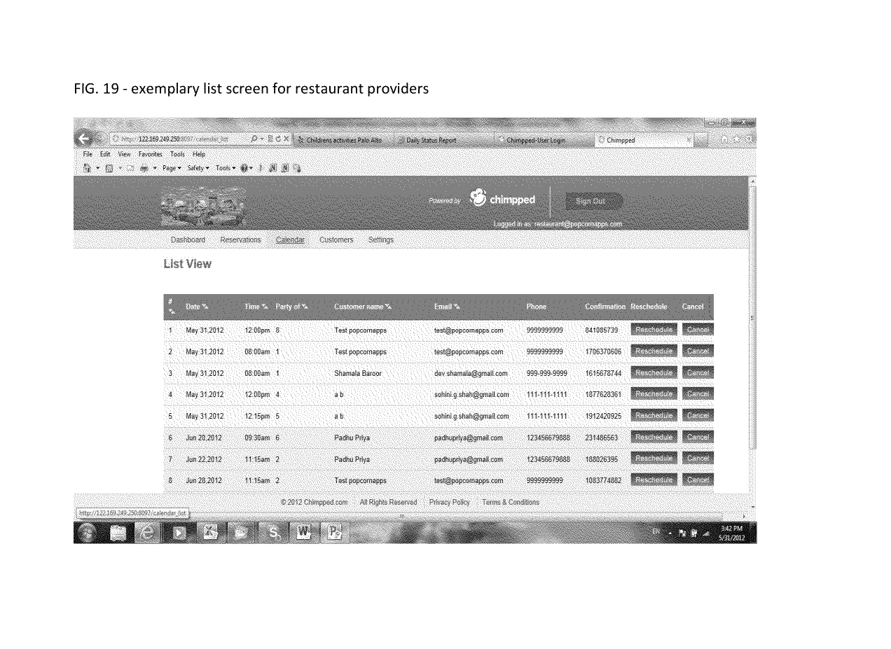

FIG. 19 shows an exemplary list screen for restaurant providers. This embodiment shows a full list of restaurant reservations. Included on the list of reservations are reservation time, reservation date, party size, and contact information of the customer.

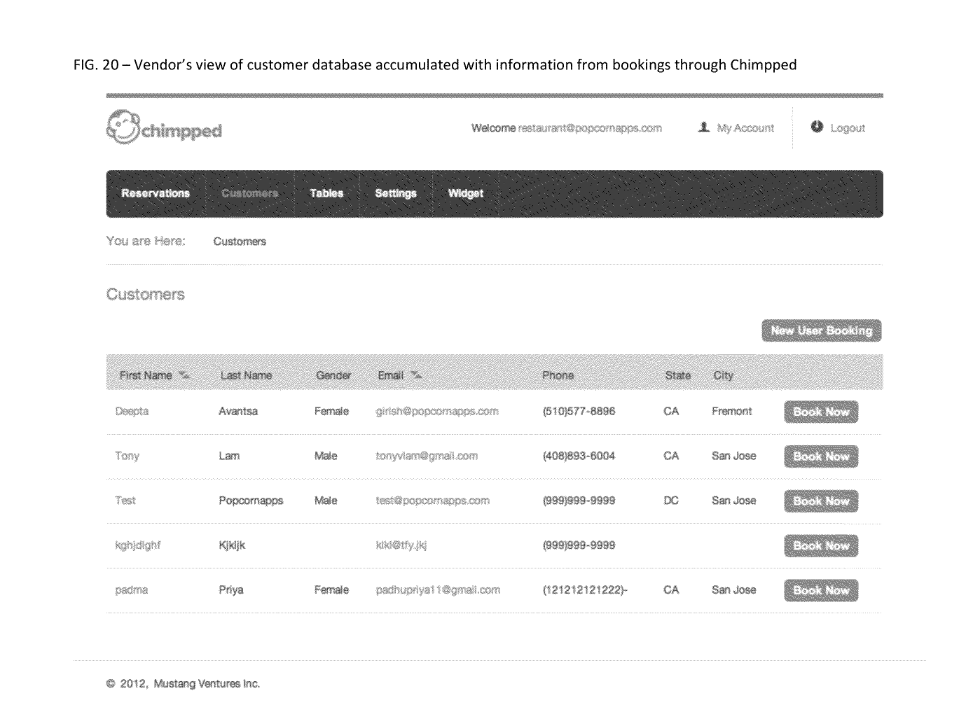

FIG. 20 shows an exemplary customer list for restaurant providers. This embodiment shows customer names, customer contact information, and city of residence. A new user booking button is included on this page to accommodate for new unlisted customers. A book now button is also included next to the customer information so that a service provider may book an appointment manually in that customer's name.

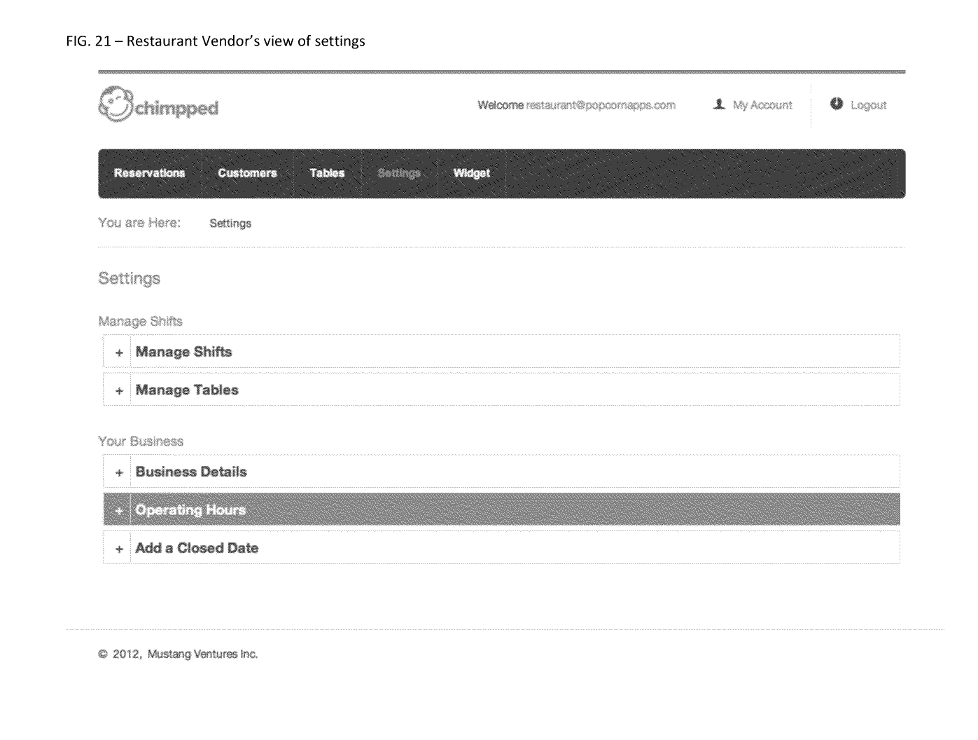

FIG. 21 shows an exemplary settings page for restaurant service providers. On this embodiment of a setting screen, business details, tables, shifts, and closed dates are shown to be editable.

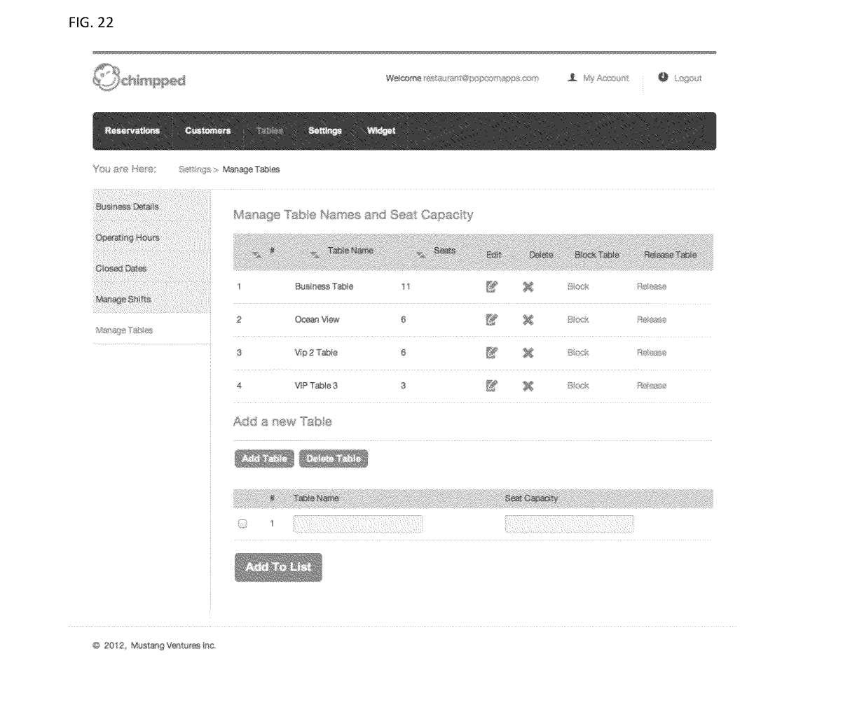

FIG. 22 shows an exemplary table details list for restaurant service providers. This embodiment shows table name, seats at the table, and options to block or release the table. Service providers can also edit table options, and add or delete tables.

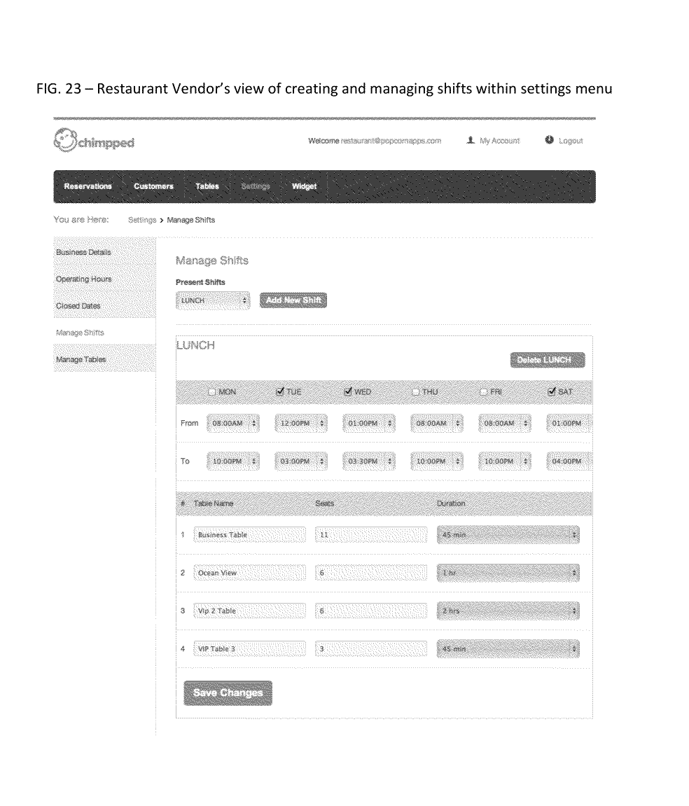

FIG. 23 shows an exemplary time assignment sheet for restaurant providers. This embodiment features the ability to change time shifts by day, time period, and table.

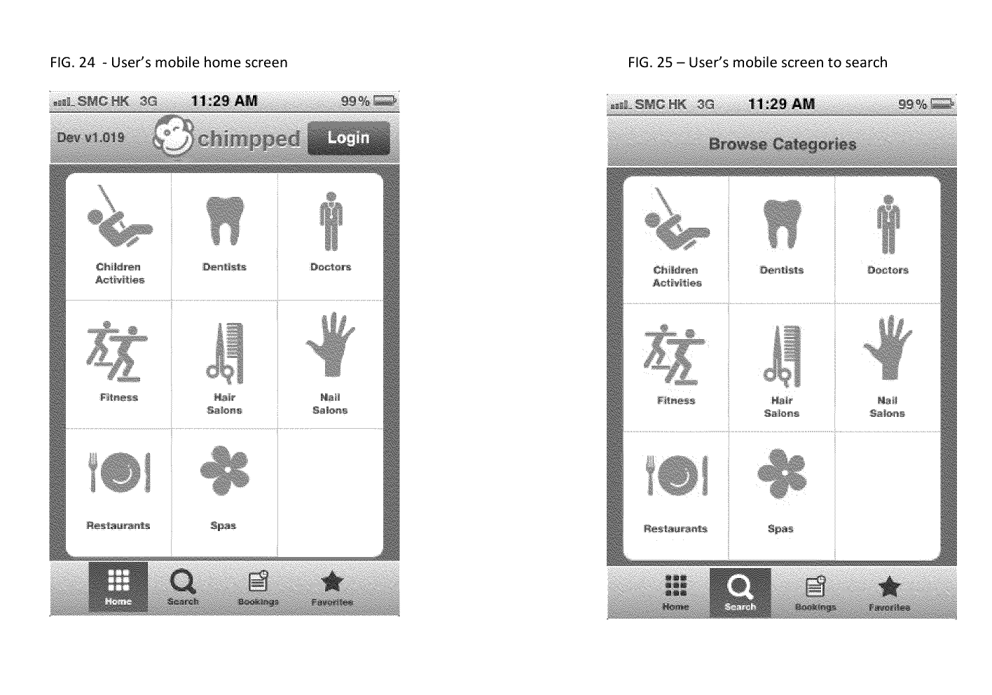

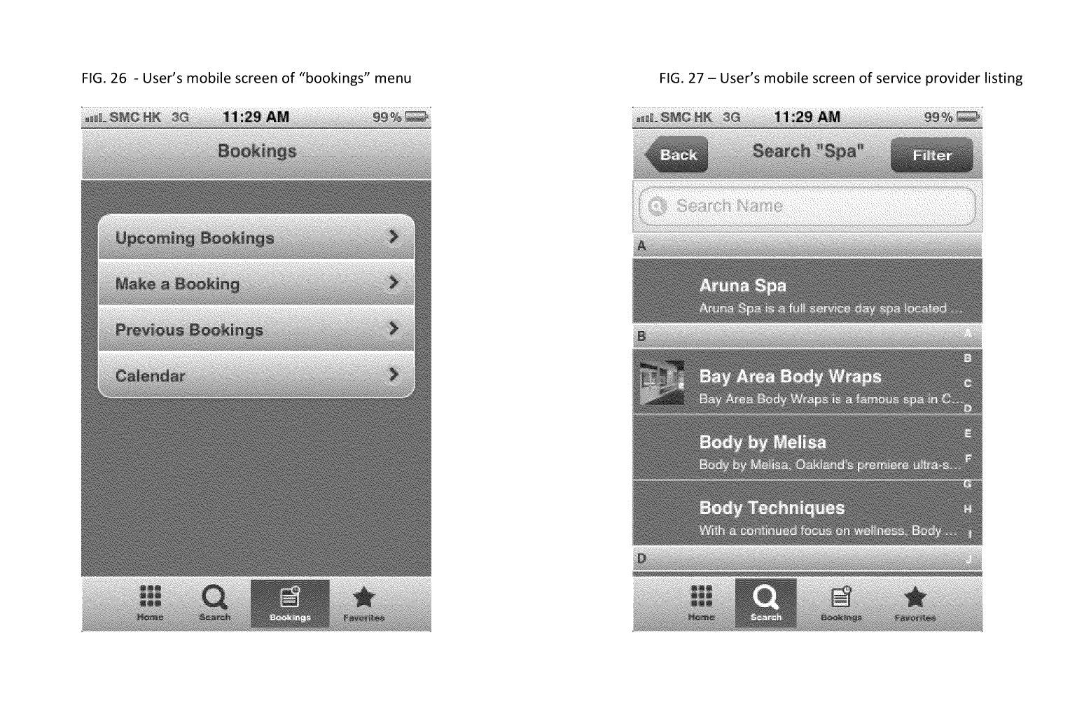

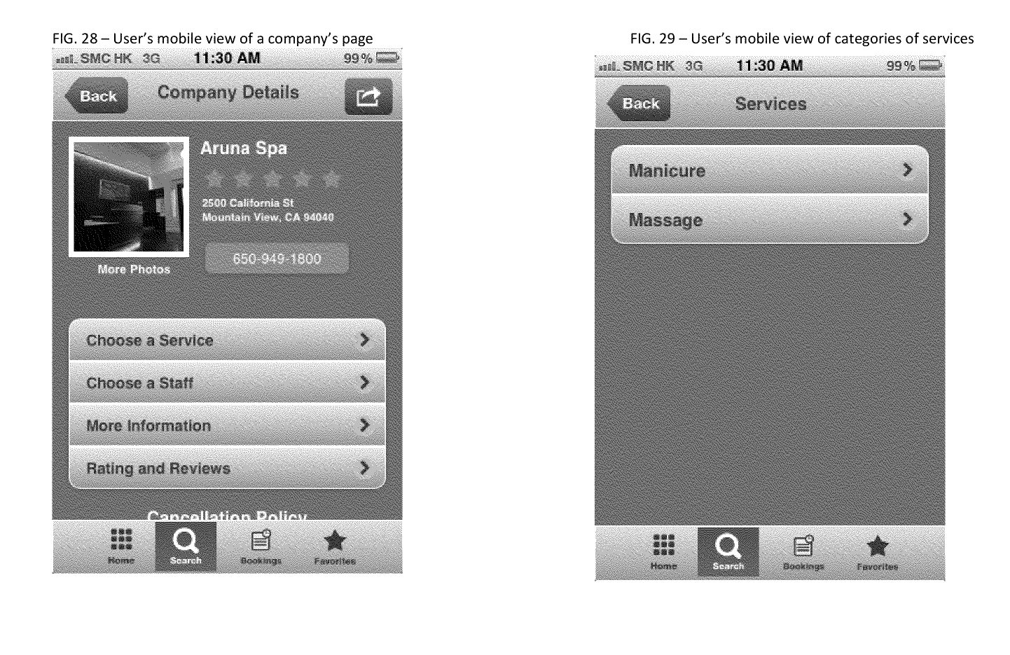

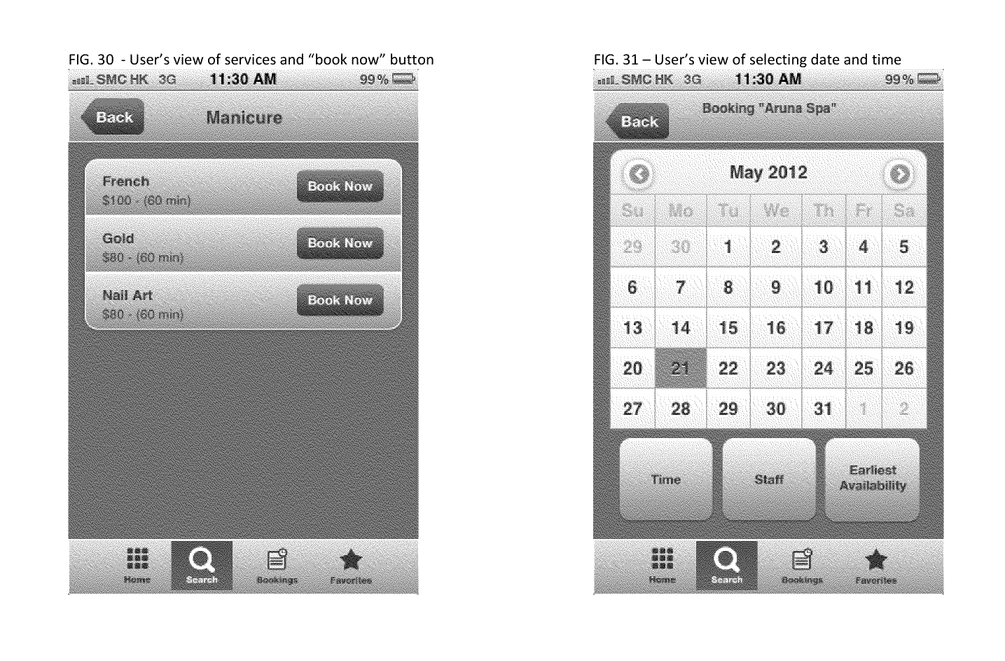

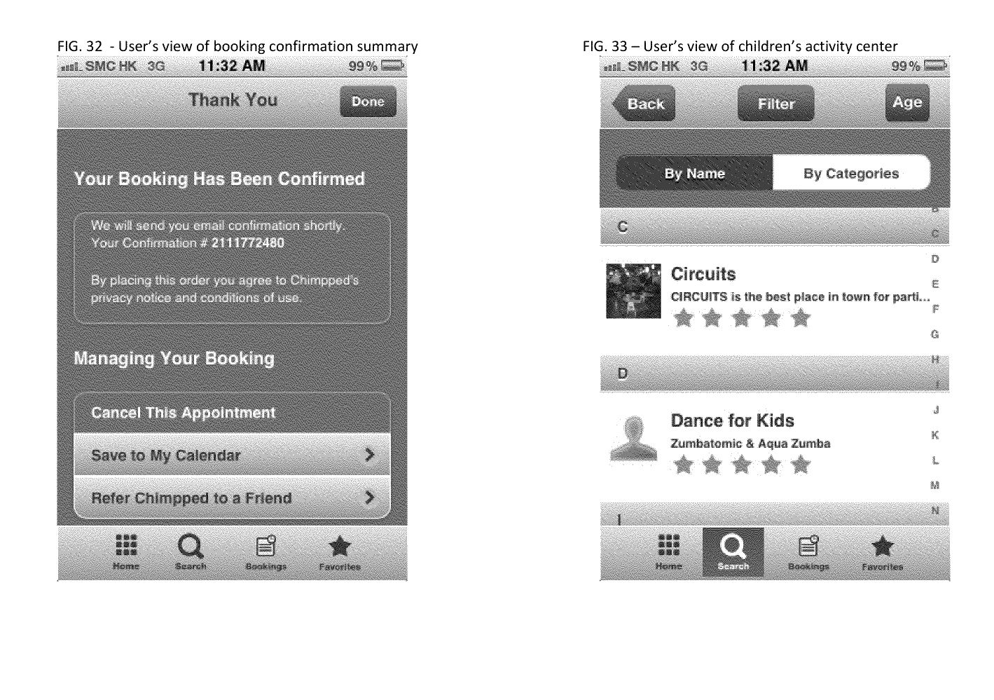

FIGS. 24-34 shows exemplary user interface screens for a mobile device. FIG. 24 shows a home landing page for a mobile application. FIG. 25 shows a search menu where users can locate a particular category for making appointments. FIG. 26 shows a user interface for making bookings, seeing current and prior bookings, and appointment calendar. FIG. 27 shows an exemplary result for particular vendors, in this case spa vendors. FIG. 28 shows details for a particular spa, while FIG. 29 shows in more details the services available from the spa. FIG. 30 shows an exemplary manicure service with different levels of services and a Book Now button for the user to select. FIG. 31 shows an exemplary booking menu using a calendar with options to book by designated time, staff, or earliest availability. FIG. 32 shows an exemplary booking confirmation user interface.

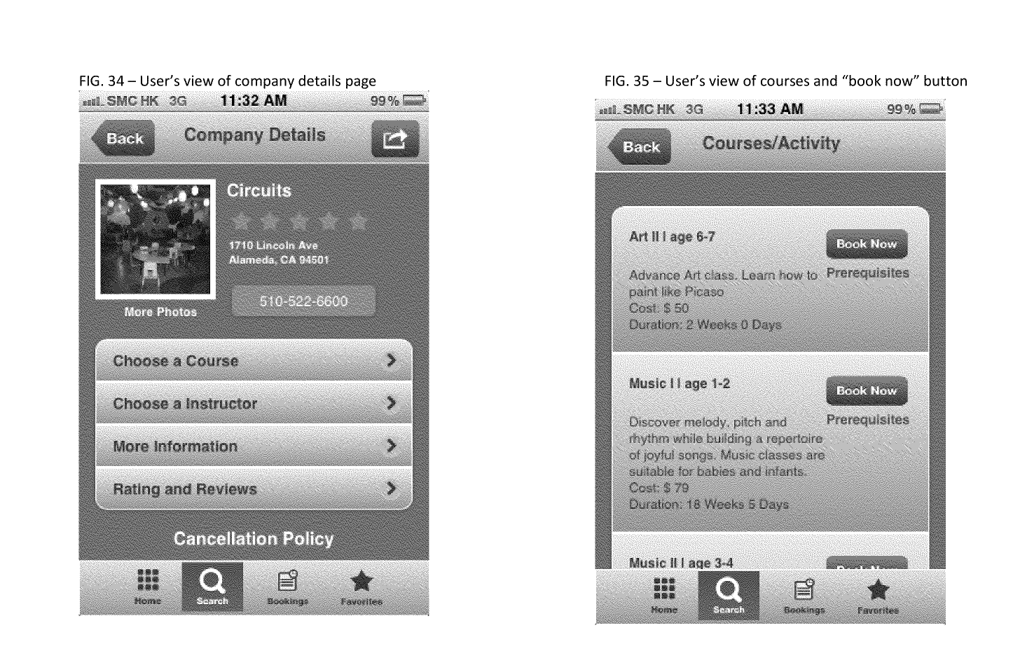

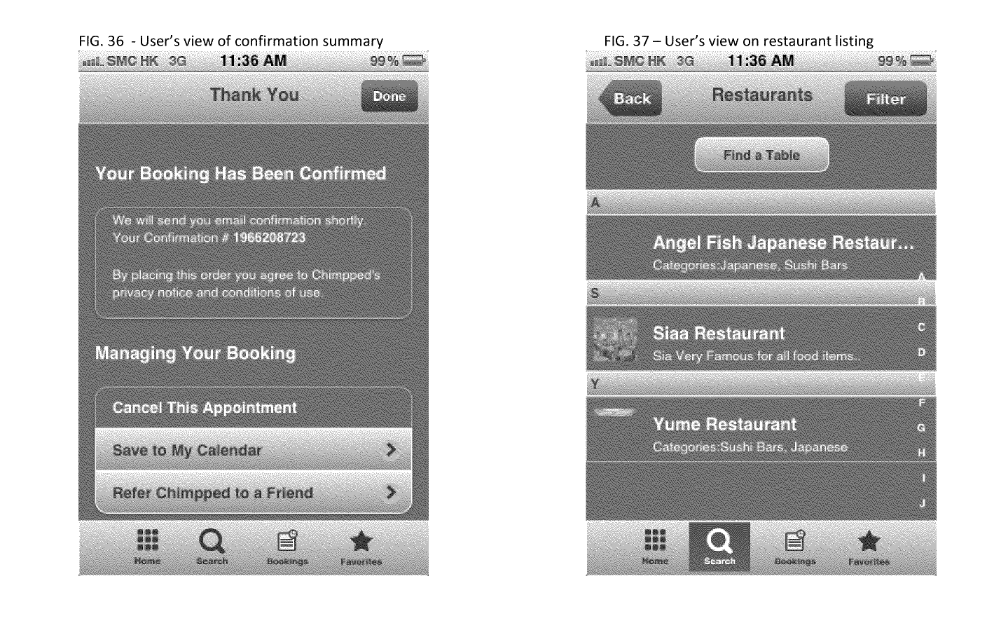

FIG. 33 shows an exemplary listing of children activity options. In this example, the listing is by name, but the listing can also be shown by categories as well. FIG. 34 shows details of a company in the children activity group. FIG. 35 shows course listings for the user to select courses for their children. If the user likes a particular course, he or she can click the Book Now button. An exemplary confirmation is shown in FIG. 36.

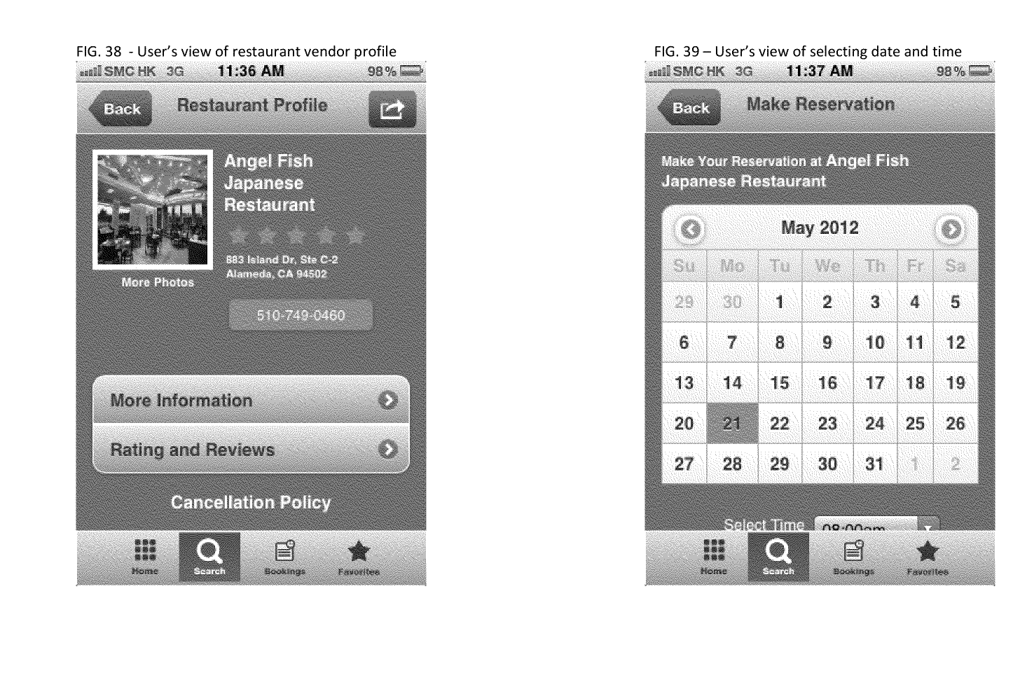

FIG. 37 shows an exemplary restaurant search result. A number of restaurants are displayed in accordance with the search criterion. The user can also click on the “Find a Table” button to quickly locate a table for a selected restaurant. FIG. 38 shows in more details an exemplary restaurant profile, while FIG. 39 shows a reservation user interface. In this reservation interface, the user selects a date and time using a calendar and time picker.

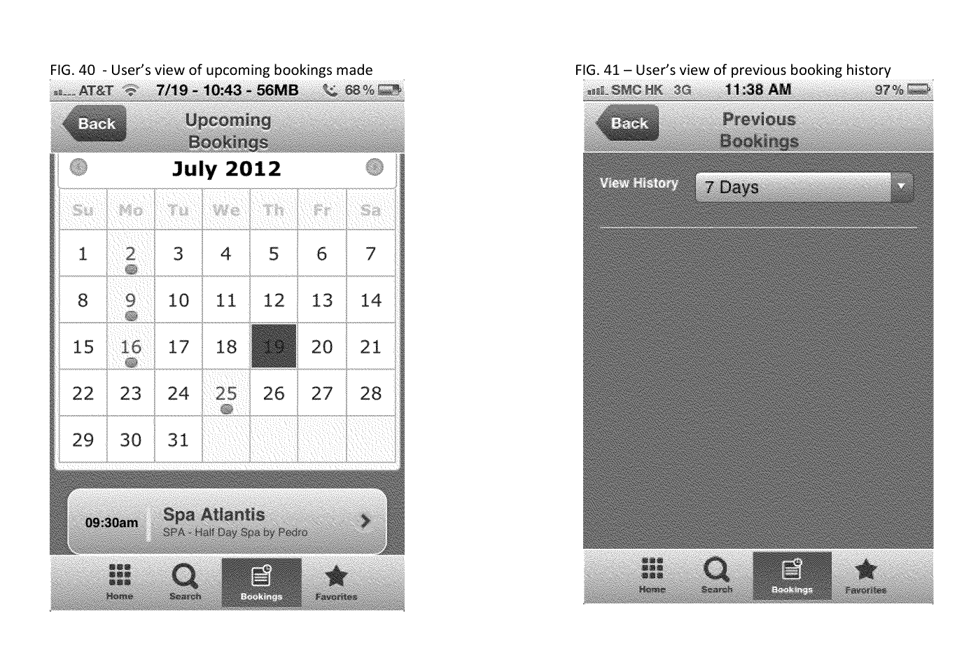

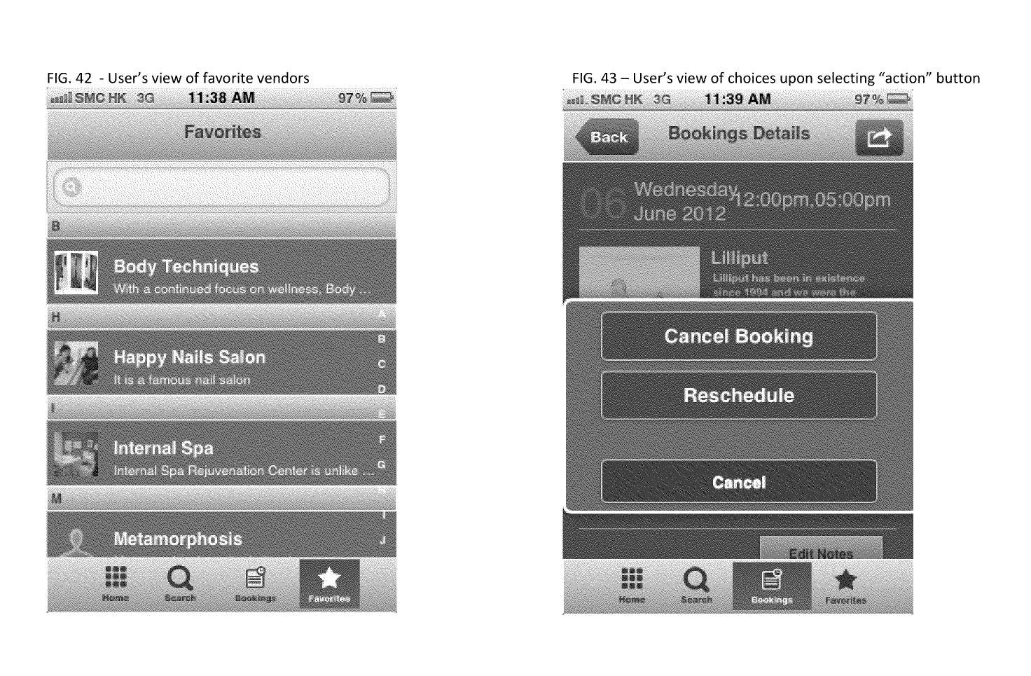

FIG. 40 shows an exemplary user interface for upcoming bookings, while FIG. 41 is a user interface that allows the user to view a history of prior booking. The user can select bookings in the past 7 days or 30 days, for example. FIG. 42 shows the user's favorite appointment places in an alphabetical order. The user can jump to a particular name by clicking on the letter on the right column. FIG. 43 shows an exemplary cancellation/rescheduling user interface to change a prior booking arrangement.

In an exemplary capacity utilization maximization process, the system takes user inputs from the web site, “Book Now” widget, and the mobile app, among others. The system also monitors the service provider calendar for open time slots. Such information is stored in an available slot database in the scheduling software. In this example, the system knows the user's interest and the user's open time slots. The system also knows the service provider's total capacity and open time slots. The system can optimize the calendars of both the user and service provider. For example, the system can recommend a different date that fits best with the user's travel path and the capacity of the service provider. In another example, the system can automatically recommend a different location of the selected service provider that fits better due to open time slots at the different location. Other optimizations can be done as well.

The system takes into consideration a total capacity limit, which is the total number of customers that can be served by a given service over a given time period. The total capacity may vary based on the size of the staff currently on duty, etc. The process can use linear scheduling and non-linear scheduling techniques. In one illustrative embodiment, the capacity utilization is based on not only a maximum total capacity over a given time period, but also a number of appointments which can be started at any given time. In one embodiment, a database structure is used to represent both maximum capacity and start time capacities to allow efficiency in searching for open appointment times and scheduling requested appointments. In another embodiment, the system utilizes various artificial intelligence (AI) based methodologies as well as a commercially available expert system shell.

The system may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next in FIG. 3. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The system has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for scheduling appointments, comprising:
storing calendars for a plurality of vendors in a plurality of industries in an online data storage device;
for each vendor, displaying a dashboard tab to show a summary, a calendar tab to access appointments, a customer tab to access customer details, and a settings tab to access vendor details;
aggregating different capacity and supply inputs for different industries and determining vendor schedule availability;
allowing a user to search for a specific vendor or vendor(s) that meet predetermined criteria;
determining if a selected vendor has an open time slot for the user; and
scheduling the appointment using a computer.

2. The method of claim 1, comprising sending notifications to one or more friends of the user to vote on venue, date and time of a meeting.

3. The method of claim 2, comprising coordinating events with the user and the friends and completing the appointment after venue, date and time are voted on and chosen.

4. The method of claim 1, comprising clicking on a predetermined button on a vendor's web site to be automatically connected to the web site.

5. The method of claim 1, comprising sending reminders to the user based on a user-selected contact channel, wherein the channels include one or more of: telephone, instant messaging, booking sites, individual company websites.

6. The method of claim 1, comprising synchronizing the appointment with a user's calendar.

7. The method of claim 1, comprising updating a vendor's operating hours, maximum capacity for each hour and duration for each type of services.

8. The method of claim 7, wherein the maximum capacity is itemized by employee or by table.

9. The method of claim 1, wherein if the vendor does not respond to the appointment request within a predetermined period, accepting the appointment.

10. The method of claim 1, comprising locally optimizing the calendar to fit an individual user's requirements and globally optimizing utilization of the system resources supporting the user seeking customized services.

11. A multi-vendor scheduling system, comprising:
means for storing calendars for a plurality of vendors in an online data storage device;
a dashboard tab to show a summary, a calendar tab to access appointments, a customer tab to access customer details, and a settings tab to access vendor details;
means for searching for a specific vendor or vendor(s) that meet predetermined criteria;
means for determining if a selected vendor has an open time slot for a user; and
means for scheduling the appointment.

12. The system of claim 11, comprising means for sending notifications to one or more friends of the user to vote on venue, date and time of a meeting.

13. The system of claim 12, comprising means for coordinating events with the user and the friends and completing the appointment after venue, date and time are voted on and chosen.

14. The system of claim 11, comprising a predetermined button on a vendor's web site to automatically connect to the web site.

15. The system of claim 11, comprising means for sending reminders to the user based on a user-selected contact channel, wherein the channels include one or more of: telephone, instant messaging, booking sites, individual company websites.

16. The system of claim 11, comprising means for synchronizing the appointment with a user's calendar.

17. The system of claim 11, comprising means for updating a vendor's operating hours, maximum capacity for each hour and duration for each type of services.

18. The system of claim 17, wherein the maximum capacity is itemized by employee or by table.

19. The system of claim 11, wherein if the vendor does not respond to the appointment request within a predetermined period, means for accepting the appointment.

20. The system of claim 11, comprising are locally optimized to suit an individual user's requirements and yet which globally optimize the utilization of the system resources supporting such customized services for each individual seeking customized services.
